(19) United States
(12) Patent Application Publication
(10) Pub. No.: US 2026/0369292 A1
(43) Pub. Date: Nov. 19, 2026

(54) AUDIO ENHANCEMENT AND OPTIMIZATION USING CONTEXTUAL AUDIO SIGNAL PROCESSING

(71) Applicant: Shure Acquisition Holdings, Inc., Niles, IL (US)

(72) Inventors: Christian Yost, Niles, IL (US); Michael Lester, Buena Vista, CO (US); Brent Shumard, Mount Prospect, IL (US); Steven Norman Leib, Evanston, IL (US); Zachary Kane, Chicago, IL (US); William Oakley, Niles, IL (US)

(21) Appl. No.: 19/677,248

(22) Filed: May 14, 2026

Related U.S. Application Data
(60) Provisional application No. 63/805,587, filed on May 14, 2025.

(51) Int. Cl. G10L 21/0232; G10L 15/02; G10L 15/16; G10L 21/0216; G10L 21/034

(52) U.S. Cl. CPC G10L 21/0232; G10L 15/02; G10L 15/16; G10L 21/034; G10L 2021/02166

(57) ABSTRACT

Techniques are disclosed herein for providing audio enhancement and optimization using contextual audio signal processing. Examples may include generating a first audio feature set for an audio stream, inputting the first audio feature set to a first neural network model configured to generate one or more contextual audio classifications for the audio stream, generating a context-specific mixed audio stream for the audio stream based on the one or more contextual audio classifications, generating a second audio feature set for the context-specific mixed audio stream, inputting the second audio feature set to a second neural network model configured to generate an audio isolation mask associated with the context-specific mixed audio stream, generating isolated audio for the context-specific mixed audio stream based on the audio isolation mask, and generating output data for an output device based on the isolated audio.

### CROSS REFERENCE TO RELATED APPLICATIONS

This application claims the benefit of U.S. Provisional Patent Application No. 63/805,587, titled “AUDIO ENHANCEMENT AND OPTIMIZATION USING CONTEXTUAL AUDIO SIGNAL PROCESSING,” and filed on May 14, 2025, the entirety of which is hereby incorporated by reference.

### TECHNICAL FIELD

Embodiments of the present disclosure relate generally to audio processing and, more particularly, to systems, methods, and computer program products for enhancing audio signals related to audio environments via contextual audio signal processing.

### BACKGROUND

Noise, reverberation, acoustic feedback, and/or other undesirable sound are often introduced during audio capture in audio environments. Through applied ingenuity, the inventors have developed solutions to such drawbacks, as disclosed herein.

### BRIEF SUMMARY

Various embodiments of the present disclosure are directed to apparatuses, systems, methods, and computer readable media for providing audio enhancement and optimization using contextual audio signal processing. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio signal processing system in accordance with one or more embodiments disclosed herein;

FIG. 2 illustrates an example audio signal processing apparatus configured in accordance with one or more embodiments disclosed herein;

FIG. 3 illustrates an example automatic microphone mixer in accordance with one or more embodiments disclosed herein;

FIG. 4A and FIG. 4B illustrate an example audio signal processing system in accordance with one or more embodiments disclosed herein;

FIG. 5 illustrates an example audio mixing system in accordance with one or more embodiments disclosed herein;

FIG. 6A and FIG. 6B illustrate an example signal flow diagram in accordance with one or more embodiments disclosed herein;

FIG. 7 illustrates an example audio signal processing subsystem in accordance with one or more embodiments disclosed herein;

FIG. 8 illustrates an example audio signal processing subsystem in accordance with one or more embodiments disclosed herein;

FIG. 9 illustrates an example pre-processing subsystem in accordance with one or more embodiments disclosed herein;

FIG. 10 illustrates an example post-processing subsystem in accordance with one or more embodiments disclosed herein;

FIG. 11 illustrates an example arena environment associated with an audio signal processing system in accordance with one or more embodiments disclosed herein;

FIG. 12 illustrates an example system in accordance with one or more embodiments disclosed herein;

FIG. 13 illustrates an example audio processing control user interface in accordance with one or more embodiments disclosed herein;

FIG. 14 illustrates another example audio processing control user interface in accordance with one or more embodiments disclosed herein; and

FIG. 15 illustrates an example method for providing audio enhancement and optimization using contextual audio signal processing in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

Various embodiments of the present disclosure address technical problems associated with audio signal processing, particularly in complex acoustic environments such as an arena environment. Traditional digital signal processing (DSP) techniques for isolating specific audio sources and/or mixing signals from multiple microphones often struggle in noisy environments, leading to suboptimal audio quality and increased complexity for post-processing of an audio stream.

In environments with higher ambient noise levels, such as arena environment, less desirable DSP techniques may have difficulty distinguishing between desired audio signals and unwanted noise in an audio stream. This may result in poor signal-to-noise ratios (SNR) and reduced clarity of the audio. Noises in certain environments such as arena environments are often non-stationary, which are typically difficult to filter using traditional DSP techniques. Additionally, less desirable audio processing systems may utilize multiple microphones within an environment, each capturing different audio sources or areas within the environment. This approach not only increases the complexity of the audio setup but also typically involves significant manual intervention from audio engineers to manage and mix the various audio streams effectively. Furthermore, less desirable audio processing systems may struggle with spatial audio representation, limiting the ability to create immersive audio experiences that accurately reflect the physical layout of the sound sources within the environment. This limitation may detract from the overall audio quality and listener experience, particularly in broadcast or recording scenarios where spatial accuracy is desirable.

In an example, noise, reverberation, acoustic feedback, and/or other undesirable audio may be introduced during audio capture operations related to microphones located in an arena environment. For arena environments, such noise, reverberation, acoustic feedback, and/or other undesirable audio affect quality of broadcast audio, broadcast video, and/or speech reinforcement associated with an arena environment, which may produce an undesirable audio experience for listeners. For example, when microphones are placed in an arena environment intended for a television or radio broadcast, the desired audio may be voice audio related to an athlete speaking to a coach and/or other non-speech sporting event noises such as a squeak of shoes worn by the athlete, bouncing of a basketball on a basketball court, the “swish” of a basketball passing through a net, and the like. However, an arena environment typically includes other audio such as, for example, sound waves from a public address (PA) announcer, audio advertisements and announcements, music, spectator sounds (e.g., crowd noise), and/or other sounds emanating from the arena environment.

Examples of the present disclosure address these challenges and more by providing contextualized audio signal processing that utilizes contextual sound for improved audio processing associated with an environment. The contextualized audio signal processing may be configured as an integrated audio signal processing system that combines advanced microphone array technology with machine learning techniques. The contextualized audio signal processing may incorporate multiple signal processing pipelines to optimize an audio stream.

In some examples, the contextualized audio signal processing may select and mix audio based on a highest probability of capturing context-specific audio, such as sports-related sounds or other desired audio events. The mixing process enabled by the contextualized audio signal processing may be spatially aware, enabling the creation of mono audio, stereo audio, or three-dimensional (3D) audio that accurately represents the environment. In some examples, the contextualized audio signal processing may utilize a microphone array configured to perform beamforming, allowing for channelization by audio source or location within the environment.

In some examples, the contextualized audio signal processing may provide improved signal-to-unwanted-signal ratios compared to less desirable audio processing systems. This may be achieved through a combination of spatial directivity optimization, advanced DSP techniques, and advanced machine learning techniques. In some examples, the contextualized audio signal processing may also enable simplified audio transport solutions for an audio processing system, reducing the complexity of signal routing and signal management.

In some examples, the contextualized audio signal processing may provide an automated process for creating sub-mix audio channels, which may enable focus of post-processing to one or more other aspects of audio production rather than technical management of multiple audio sources. This automation may significantly reduce computing resources of audio post-processing and may also improve overall efficiency in live audio production scenarios.

By integrating multiple DSP and machine learning functionalities into a single system, the contextualized audio signal processing may reduce the number of microphone units and signal paths for an audio processing system. In some examples, the contextualized audio signal processing may enable audio filtering functionality such as removing crowd sounds, eliminating sound system feedback, reducing reverberation, and/or filtering non-speech or non-context-specific noises. In some examples, the system may allow for user control over various aspects of the audio processing, including localization of audio generation events, beamforming parameters, equalization, compression, automatic gain control, and/or mixing characteristics.

As such, the contextualized audio signal processing may enable fine-tuning of the audio system performance for specific use cases or acoustic environments. Accordingly, by combining advanced microphone array technology with context-aware processing and machine learning techniques, the contextualized audio signal processing may enable a significant advancement in audio signal processing for complex acoustic environments. By addressing multiple technical challenges simultaneously, the contextualized audio signal processing may also provide a comprehensive solution for high-quality audio capture, processing, and/or mixing in challenging scenarios such as sports broadcasting or live event production. As such, enhanced audio for an audio environment may be provided.

### Example Audio Signal Processing Systems

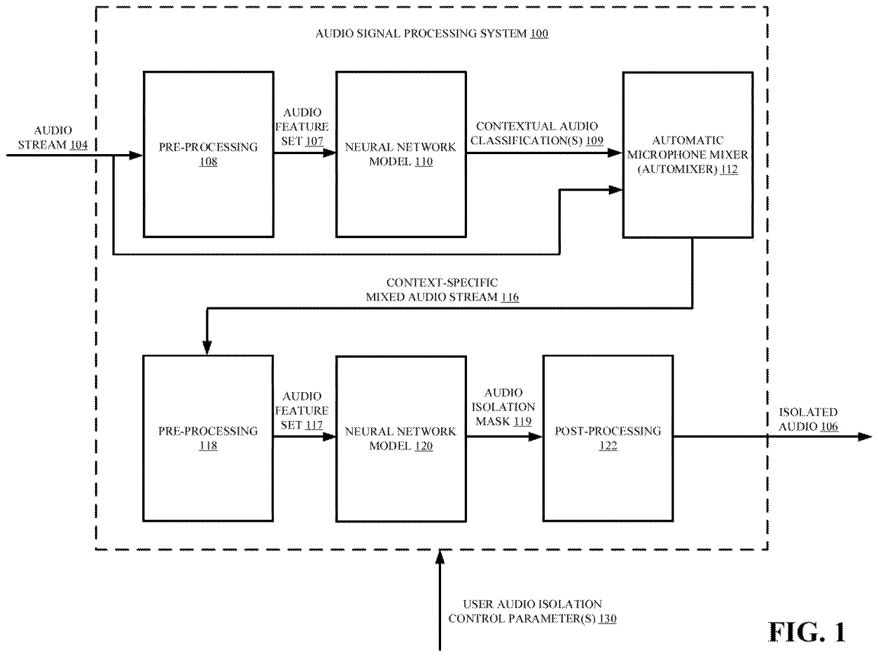

FIG. 1 illustrates an audio signal processing system 100 that is configured to provide audio enhancement and optimization using contextual audio signal processing, according to embodiments of the present disclosure. The audio signal processing system 100 may provide audio enhancement for an immersive audio experience (e.g., an immersive arena based audio experience) associated with an audio environment by utilizing contextual sound for audio processing. In some examples, the audio signal processing system 100 provides isolated audio and/or improved audio signal quality for audio captured in an audio environment by utilizing contextual sound for audio processing. The isolated audio may also enable removing and/or suppressing noise, reverberation, acoustic feedback, and/or other undesirable characteristics associated with audio captured in an audio environment. The isolated audio may correspond to desirable audio for broadcast audio, broadcast video, and/or speech reinforcement. Further, the isolated audio may be of similar class but isolated (e.g., such as single voices being preserved in the isolated audio while crowd sounds which typically consist of many voices together being removed). In some examples, the audio signal processing system 100 may be an arena audio signal processing system for an arena environment.

The audio signal processing system 100 may utilize contextual audio signal processing to provide context-specific isolated audio associated with an audio environment such as, but not limited to, an arena environment. The audio environment may be an indoor environment or an outdoor environment. In some examples, the contextual audio signal processing may utilize output from one or more neural network models trained based on an audio feature set extracted from an audio stream captured in the audio environment. In some examples, the contextual audio signal processing may utilize output from an audio mixer (e.g., an automixer) and/or a voice activity detector applied to the audio stream.

The disclosed techniques for the audio signal processing system 100 may be implemented for an audio environment such as, but not limited to, an arena environment to capture audio signal streams, isolate the audio signal streams based on class and/or locality, select desired audio classes and/or locales, and generate an immersive audio stream that is configured for output via television broadcast, audio streaming, video streaming, a speech reinforcement system, or other media service. As described herein, an arena environment may refer to any building, venue, facility, or space comprising a playing region (or performance region) as well as a spectator region. In some examples, an arena environment may further include a noise source region.

An arena environment may be an audio environment for a live event and/or a broadcast related to sports, entertainment, music, theater, a presentation, and/or another type of audio application. Additionally, an arena environment may be an indoor audio environment or an outdoor audio environment. In a non-limiting example, an arena environment may include: an indoor sporting arena (e.g., sports stadium or arena, basketball arena, football stadium, hockey stadium, soccer stadium, boxing arena, or the like); an indoor entertainment arena (e.g., concert hall, theater, auditorium, or the like); an outdoor stadium environment (e.g., an outdoor football stadium, an outdoor baseball stadium, a soccer stadium, a concert venue, or the like); an outdoor sporting event (e.g., an outdoor basketball court, an outdoor extreme sports competition, or the like), a broadcasting environment, or another similar environment in which audio signal streams are captured to create and provide an immersive audio experience. However, although the present disclosure is described with respect to an arena environment for purposes of illustration, it is to be appreciated that the present disclosure is not limited to arena environments.

A playing region refers to a portion of an arena environment in which performers are designated to perform. A playing region may include: a basketball playing surface, a football field, an ice surface of a hockey stadium, a field area of a soccer field, a field area of a baseball field, a stage of an entertainment arena (e.g., a concert hall, theater, or the like), or another similar participant region of an arena environment. A noise source region refers to a portion of an arena environment from which additional sound waves (e.g., in addition to the playing region) may emanate. In some examples, a noise source region may include: sound waves from a public address (PA) announcer, audio advertisements and announcements, music, spectator sounds (e.g., crowd noise), and/or other sounds emanating from the arena environment.

Some undesirable approaches to producing an immersive audio experience for an audio environment involve positioning numerous static, directional, and analog microphones around an arena environment. The imperfect directionality of these microphones allows unwanted sounds (such as music, PA audio, spectator sounds, etc.) to be included in the output audio stream.

In addition, if a broadcast television producer desires to capture audio in new directions or from another source, the directional microphones must be manually moved by an operator. Manual movement of directional microphones is also required when the target source of the audio capture moves around the arena environment. This may be particularly problematic in large arena environments such as football stadiums, soccer stadiums, baseball stadiums, and the like.

Capturing sufficient localized audio signal streams to create an immersive experience using directional microphones also requires many directional microphones and accompanying cabling to point to the various areas of interest in an arena environment. Finally, in-game audio produced from directional microphones must be manually mixed by an engineer by selecting specific audio sources to enable and disable, which may be difficult to execute during a live broadcast.

The audio signal processing system 100 may be utilized to overcome the aforementioned drawbacks and more by integrating contextual awareness, neural network-based processing, and/or user-controllable isolation parameters to produce high-quality, context-specific isolated audio for an audio environment. In some examples, the audio signal processing system 100 may enable utilization of a single a sound wave capture device (e.g., a microphone array, a 1.5D microphone array, a 2D linear and planar microphone array, a 3D surface arrays of microphone, a 3D suspended arrays of microphones, etc.) in an audio environment. A 1.5D microphone array is a microphone array configured to provide a one-dimensional form factor that, in some embodiments, has added directivity, for most, if not all, frequencies, in dimensions that, conventionally, have equal sensitivity in all directions.

The audio signal processing system 100 further provides for processing of audio signal streams to improve audio quality through artificially intelligent (AI) audio isolation, denoising, acoustic echo cancellation, and/or speech removal. Example techniques further provide for identification and classification of audio sources, localization of captured audio signal streams, and selection and generation of an immersive audio stream. Accordingly, the audio signal processing system 100 may be utilized to overcome technical problems associated with capturing, processing, and/or generating audio signal streams (e.g., collection of audio data) associated with an arena environment to provide an immersive audio experience for a remote spectator of a sporting event or other performance.

The audio signal processing system 100 may utilize one or more capture devices to capture an audio signal stream from an arena environment. For example, a multi-lobe capture device may be configured to define beamformed lobes based on locality. Utilizing a multi-lobe capture device to define beamformed lobes may provide coverage of a wide area while still allowing focused selection of specific regions of interest. In some examples, a multi-lobe capture device may be a steerable digital sound wave capture device or a switchable digital sound wave capture devices configured with multiple beamformed lobes. Use of a multi-lobe capture device also provides for enhanced audio region selectivity while minimizing the number of needed audio capture devices by selectively updating the audio capture area based on the desired immersive audio experience.

In some examples, the audio signal processing system 100 is configured to use advanced audio processing techniques, such as separation and classification of audio sources, to further classify and focus the captured audio streams. For example, in circumstances where an arena environment includes a basketball court, the audio signal processing system 100 may utilize one or more machine learning models and/or an AI module disposed in a digital signal processing chain to classify an audio signal stream source as voice, conversation, ball sounds, player exclamations, or PA sounds. Similarly, in circumstances where an arena environment includes a baseball field, the one or more machine learning models and/or AI module of the audio signal processing system 100 may classify the crack of the bat, the slap of the glove, exclamations from the dugout, or other sounds that may contribute to the overall spectator experience.

The audio signal processing system 100 may additionally suppress certain types of noise in an audio environment while still allowing other types of noises to pass through an audio channel. For example, noise created by spectators and/or a sound reinforcement system at a sporting event may be suppressed while still allowing natural sounds from the sporting event to pass though audio channels. In some examples, the audio signal processing system 100 may utilize one or more machine learning models to isolate desired sports sounds from undesired crowd and stadium sounds.

Insights from the one or more machine learning models may be utilized to: enhance audio for arena environments, control and/or optimize an audio system through feedback from the one or more AI models, optimize audio characteristics of individual channels to allow to provide an optimal audio mixture for a broadcast or a sound reinforcement scenario related to a sporting event or another type of event in an arena environment. In some examples, an immersive audio experience for a remote spectator may be created by virtually positioning the remote spectator within a particular region of an arena environment (e.g., a playing region, a spectator region, playing region adjacent area, etc.) while also optimizing the audio experience (e.g., amplifying or enhancing preferred sounds while filtering or removing undesirable sounds) for the particular region of the arena environment.

The audio signal processing system 100 is configured to perform contextual audio signal processing to optimize at least audio isolation, denoising, speech removal, and/or other filtering of sound with respect to an audio stream 104. As illustrated in FIG. 1, the audio signal processing system 100 includes pre-processing 108, a neural network model 110, an automatic microphone mixer (automixer) 112, pre-processing 118, a neural network model 120, and/or post-processing 122. The audio signal processing system 100 may to perform contextual audio signal processing with respect an audio stream 104 to provide isolated audio 106. In some examples, the audio stream 104 originates from one or more capture devices positioned within an audio environment. For example, the audio stream 104 may be generated by a transducer device such as a microphone or a microphone array.

The isolated audio 106 may refer to a transformed version of the audio stream 104 that has been processed via contextual-based audio mixing and machine learning to separate and/or isolate specific audio components from a context-specific mixed audio stream version of the audio stream 104. Additionally, the isolated audio 106 may be an isolated audio signal, isolated audio channel data, or an isolated audio stream that has been processed via contextual-based audio mixing and machine learning to emphasize or extract specific desired audio components while suppressing or removing undesirable audio components. In some examples, the isolated audio 106 is isolated arena audio associated with an arena environment.

The audio signal processing system 100 may be configured as an intelligent DSP system configured to perform at least audio isolation, denoising, speech removal, and/or other filtering of sound with respect to the audio stream 104 via digital signal processing and machine learning. In some examples, the audio signal processing system 100 is an intelligent digital signal processor configured to perform at least audio isolation, denoising, speech removal, and/or other filtering of sound with respect to the audio stream 104 via digital signal processing and machine learning.

The audio stream 104 may include one or more microphone signals. In some examples, the audio stream 104 may include one or more commentator microphone signals, one or more arena sound microphone signals, and/or one or more reference microphone signals. Additionally, the audio stream 104 may be captured via one or more capture devices within an arena environment. The one or more capture devices may include one or more sensors configured for capturing audio by converting sound into one or more electrical signals. The audio captured by the one or more capture devices may also be converted into the audio stream 104 (e.g., the commentator microphone signal, the one or more arena sound microphone signals, and/or the reference microphone signal). The audio stream 104 may be digital audio or, alternatively, analog audio. In some examples, the audio stream 104 is generated via one or more transducer capture devices such as, for example, one or more linear array sound wave capture devices. Further, the audio signal processing system 100 may receive the audio stream 104 from an audio mixer device.

In some examples, the one or more capture devices associated with the audio stream 104 are one or more microphones. For instance, the one or more capture devices may correspond to one or more condenser microphones, one or more micro-electromechanical systems (MEMS) microphones, one or more dynamic microphones, one or more piezoelectric microphones, one or more microphone arrays, one or more linear microphone arrays, one or more ceiling microphone arrays, one or more ambisonic microphones, one or more table microphone arrays, one or more virtual microphones, one or more network microphones, one or more ribbon microphones, or another type of microphone configured to capture audio. In some examples, the one or more capture devices generate and/or utilize one or more beamformed lobes to enable capture of audio. In some examples, the one or more capture devices include a plurality of multi-lobe capture devices. However, it is to be appreciated that, in some examples, the one or more capture devices may additionally or alternatively include one or more video capture devices, one or more infrared capture devices, one or more sensor devices, and/or one or more other types of audio capture devices.

The one or more capture devices may be positioned at one or more locations within the arena environment. For example, the one or more capture devices may be positioned within the arena environment and may be configured to direct one or more first beamformed lobes to a playing region of the arena environment, one or more second beamformed lobes to a spectator region of the arena environment, and one or more third beamformed lobes to a noise source region of the arena environment.

The audio signal processing system 100 may generate an audio feature set 107 for the audio stream 104 captured in the arena environment. The audio feature set 107 may be a model input audio feature set for a neural network model 110 utilized by the audio signal processing system 100 for providing one or more contextual audio classifications 109 associated with the audio stream 104.

The audio feature set 107 may be a collection of audio characteristics extracted from the audio stream 104. Additionally, the audio feature set 107 may comprise features to enable contextual audio classification of the audio stream 104. The audio feature set 107 be utilized as input data for one or more subsequent audio processing stages of the audio signal processing system 100. For example, the audio feature set 107 be utilized as input data for the neural network model 110.

The audio feature set 107 may be generated through various digital signal processing techniques applied to raw audio data of the audio stream 104. These digital signa processing techniques may include time-domain analysis, frequency-domain transformations, and/or statistical measures of the audio stream 104. In some examples, the audio feature set 107 may be related to a Bark scale filter of a magnitude spectrum associated with the audio stream 104 to indicate psychoacoustic relevance associated with the audio stream 104.

The audio feature set 107 may also be related to a complex frequency spectrum associated with the audio stream 104. In some examples, the audio signal processing system 100 may utilize learnable filter banks as part of the audio feature set 107. The filter banks may be dynamically adapted during training of the neural network model 110 to enable the audio signal processing system 100 to optimize feature extraction specifically for contextual audio classification tasks.

The feature set may comprise spectral features and/or temporal features. In some examples, the audio feature set 107 comprises: one or more: audio spectrum features, magnitude features, phase features, pitch features, harmonic features, Mel spectrogram features, wavelet transform features, Mel-frequency cepstral coefficients (MFCC) features, performance features, performance sequencer features, tempo features, time signature features, spectral centroid features, spectral flux features, zero-crossing rate features, energy envelope features, features related to an Equivalent Rectangular Bandwidth (ERB) scale, Short-Time Fourier Transform (STFT) features, filter bank features, and/or other types of features associated with the audio stream 104. Features for the audio feature set 107 may be selected to improve accuracy of contextual classifications and/or the overall performance of the audio signal processing system 100. Additionally, selection and/or combination of features in the audio feature set 107 may be tailored to enhance performance of the neural network model 110 to enable accurate generation of contextual audio classifications 109 for the audio stream 104.

The audio spectrum features represent physical features of the audio stream 104 such as frequency characteristics and/or distribution of energy measurements with respect to the audio stream 104. The magnitude features may represent physical features of the audio stream 104 such as magnitude measurements with respect to the audio stream 104. The phase features may represent physical features of the audio stream 104 such as phase measurements with respect to the audio stream 104. The pitch features may represent perceptual features of the audio stream 104 such as frequency characteristics related to pitch for the audio stream 104. The harmonic features may represent perceptual features of the audio stream 104 such as frequency characteristics related to harmonics for the audio stream 104.

The MFCC features may represent physical features of the audio stream 104 such as MFCC measurements with respect to the audio stream 104. The MFCC measurements may be extracted based on windowing operations, digital transformations, and/or warping of frequencies on a Mel frequency scale with respect to the audio stream 104.

The performance features may represent perceptual features of the audio stream 104 such as audio characteristics related to performance of the audio stream 104. In some examples, the performance features may be obtained via one or more audio analyzers that analyze performance of the audio stream 104. The performance sequencer features may represent perceptual features of the audio stream 104 such as audio characteristics related to performance of the audio stream 104 as determined by one or more audio sequencers that analyze characteristics of the audio stream 104.

The tempo features may represent perceptual features of the audio stream 104 such as beats per minute characteristics related to tempo for the audio stream 104. The time signature features may represent perceptual features of the audio stream 104 such as beats per musical measure characteristics related to a time signature for the audio stream 104.

In some examples, the audio signal processing system 100 applies pre-processing 108 to the audio stream 104. In some examples, the audio signal processing system 100 may apply respective pre-processing 108 to respective microphone signals. The pre-processing 108 may generate one or more portions of the audio feature set 107. For example, the pre-processing 108 may perform one or more feature extraction techniques with respect to the audio stream 104 to generate one or more portions of the audio feature set 107. The pre-processing 108 may also utilize specialized DSP algorithms implemented on the audio signal processing system 100, a processor associated with the audio signal processing system 100, or specialized hardware on the audio signal processing system 100 to efficiently extract relevant features from the audio stream 104. In some examples, the audio stream 104 may be stored in memory as arrays or matrices for further processing.

The audio feature set 107 may be utilized as a dataset for contextual audio classification and/or one or more subsequent processing stages. In some examples, the audio feature set 107 is input to the neural network model 110. The audio signal processing system 100 may include the neural network model 110. Alternatively, the audio signal processing system 100 may be communicatively coupled the neural network model 110. The neural network model 110 may be configured to contextualize the audio stream 104 based on the audio feature set 107 associated with the audio stream 104. For example, the neural network model 110 may enable an understanding of context and/or content of the audio stream 104.

The neural network model 110 may be a trained neural network model 110 that is trained to recognize and classify various audio contexts. The neural network model 110 may be configured as a deep learning architecture, such as a convolutional neural network (CNN), recurrent neural network (RNN), or a hybrid model combining multiple architectures. In some examples, the neural network model 110 may include multiple layers of artificial neurons, each performing specific transformations on the audio feature set 107. These layers may include convolutional layers for feature extraction, pooling layers for dimensionality reduction, and/or fully connected layers for classification. In some examples, the neural network model 110 may utilize one or more machine learning libraries and/or machine learning frameworks optimized for neural network computations.

The neural network model 110 may also leverage hardware acceleration techniques, such as GPU processing, to enhance computational efficiency with respect to processing of the audio feature set 107. In some examples, parameters, weights, and/or architecture of the neural network model 110 may be stored in memory, with forward pass computations performed by a processor or dedicated neural processing units of the audio signal processing system 100.

The neural network model 110 processes the audio feature set 107 to generate the one or more contextual audio classifications 109. The one or more contextual audio classifications 109 may respectively be a classification output generated by the neural network model 110. Additionally, one or more contextual audio classifications 109 may respectively predict a class of audio for the audio stream 104. A class of audio may refer to a category or type of audio content that may be identified within the audio stream 104. A class of audio may also represent a classification of audio based on characteristics such as the type of sound, the specific context, or the presence of particular audio events.

The one or more contextual audio classifications 109 may represent various aspects of audio content for the audio stream 104 such as the type of sound (e.g., speech, music, ambient noise), the specific context (e.g., sports event, concert, conversation), or the presence of particular audio events. An example of a contextual audio classification of the one or more contextual audio classifications 109 is a particular type of sporting event (e.g., basketball or baseball, etc.). Another example of a contextual audio classification of the one or more contextual audio classifications 109 is a particular type of non-speech sporting event sound (e.g., non-speech sporting event noises such as a squeak of shoes worn by the athlete, bouncing of a basketball on a basketball court, the “swish” of a basketball passing through a net, and the like, etc.). Yet another example of a contextual audio classification of the one or more contextual audio classifications 109 is a particular type of voice event (e.g., commentator audio or announcer audio, etc.).

The neural network model 110 may also be trained to generate contextual audio classifications 109 specific to a particular sport to enable the audio signal processing system 100 to adapt audio processing based on the unique acoustic characteristics of the particular sport. For basketball, the contextual audio classifications 109 may include categories such as ball bounces, shoe squeaks, net swishes, and/or rim bounces. In contrast, for baseball, the contextual audio classifications 109 may focus on sounds such as bat cracks and/or glove smacks. Hockey-specific classifications may encompass puck hits, skating sounds, barrier impacts, and/or pad hits. Thus, the audio signal processing system 100 may utilize sport-specific contextual audio classifications to optimize audio processing for a particular sporting environment.

The contextual audio classifications 109 may account for the temporal characteristics of different sports sounds. For instance, in sports with frequent transient sounds, the audio signal processing system 100 may be configured to rapidly identify and process these sounds for inclusion in a broadcast feed. Conversely, for sports where highlighting specific sounds might be distracting unless the specific sounds occur with sufficient frequency or intensity, the audio signal processing system 100 may adjust audio processing and/or training of the neural network model 110 accordingly. In some examples, the contextual audio classifications 109 may extend beyond sports to include voice-based contexts. For instance, the neural network model 110 may be trained to identify and isolate sports commentators speaking in an arena environment with significant crowd noise. Similarly, the audio signal processing system 100 may be adapted for other voice-centric scenarios, such as broadcast interviews or theatrical performances where it is desirable to isolate particular voice content from environmental or stage sounds.

The neural network model 110 may also generate multiple contextual audio classifications 109 for the audio stream 104. This approach may allow the audio signal processing system 100 to handle complex audio scenarios where multiple contexts or audio events coexist. For example, the neural network model 110 may simultaneously classify the audio stream 104 as containing both a specific type of sporting event (e.g., basketball) and a particular type of non-speech sporting event sound (e.g., the bouncing of a basketball). In some examples, the audio signal processing system 100 may employ a scoring technique to evaluate and/or prioritize the multiple contextual audio classifications 109. The scoring mechanism may consider factors such as the confidence level of each classification, the relevance to the current processing task, and/or predefined priority rules.

The highest-scoring classification or a combination of high-scoring classifications may be selected for one or more subsequent audio processing stages. In some examples, the scoring and selection process may be dynamically adjusted based on user preferences, system requirements, and/or the specific requirements for downstream processing such as downstream processing provided by the automixer 112. As such, the audio signal processing system 100 may utilize a multi-classification approach with scoring-based selection to enhance flexibility and/or accuracy of the audio signal processing system 100 with respect to audio environments and/or audio processing tasks.

In some examples, the neural network model 110 generates an audio contextualization mask associated with the audio stream 104 based on the audio feature set 107. The audio contextualization mask may include a set of weighting factors or filters that may be applied to the audio stream 105 to identify specific audio features based on contextual relevance. For example, an audio contextualization mask may identify audio characteristics that are indicative of a particular contextual content. The audio contextualization mask may be utilized as an intermediate data structure that may be utilized to generate of contextual audio classifications. For instance, the one or more contextual audio classifications 109 for the audio stream 104 may be generated based on the audio contextualization mask.

The one or more contextual audio classifications 109 may be utilized as input for one or more subsequent processing stages of the audio signal processing system 100. For example, the automixer 112 may utilize the one or more contextual audio classifications 109 to guide mixing decisions for the audio stream 104. As such, a main audio path output of the automixer 112 may be determined based on the audio stream 104 and the one or more contextual audio classifications 109. The neural network model 110 may be trained on a diverse dataset of audio samples with corresponding contextual labels. The training process for the neural network model 110 may enable the neural network model 110 to learn patterns and relationships between audio features and contextual classifications. In some examples, the neural network model 110 may support fine-tuning capabilities, allowing the neural network model 110 to adapt to specific acoustic environments or use cases over time.

The automixer 112 generates a context-specific mixed audio stream 116 for the audio stream 104 based on the one or more contextual audio classifications 109. For example, the automixer 112 may adjust gain or other mixing parameters associated with the audio stream 104 based on the one or more contextual audio classifications 109 to optimize an audio mix for predicted audio context. In some examples, the automixer 112 may adapt gain associated with the audio stream 104 based on the one or more contextual audio classifications 109.

The automixer 112 may control a noise adaptive threshold, a gating decision, and/or a degree of panning for the audio stream 104 based on the one or more contextual audio classifications 109. For example, based on the one or more contextual audio classifications 109, the automixer 112 may increase or decrease a noise adaptive threshold for the audio stream 104, control a gating decision to selectively activate or deactivate specific audio channels of the audio stream 104, and/or control a degree of panning associated with the audio stream 104.

In some examples, each context specific automixer path may include other signal processing, relevant to that context, to condition the signal for a respective audio buss. A respective processing audio buss may include one or more DSP processing elements such as EQ, compression, AGC, etc. In some examples, the parameters of the DSP processing may be pre-selected based on the knowledge of the context. The parameters of the DSP processing may also be adaptive selected based on the content of the signal.

The audio signal processing system 100 may also utilize the energy levels in filtered audio streams as control signals for automixing decisions based on the contextual audio classifications 109. In some examples, the automixer 112 may dynamically adjust mixing settings in response to the relative energy content of different audio signals after the audio signals are processed according to their respective contextual classifications. For instance, when processing multiple audio signals, the audio signal processing system 100 may encounter a scenario where a first audio signal contains predominantly public address (PA) system audio, while a second audio signal captures the sounds of a basketball game.

After applying the appropriate filtering based on the contextual audio classifications 109, the PA-dominated signal may be significantly attenuated, while the basketball game signal may retain much of its original energy. In this case, even if the initial PA signal had higher overall energy, the automixer 112 may prioritize and select the basketball game signal for output based on its retained energy post-filtering. As such, the audio signal processing system 100 may utilize intelligent mixing decisions that align with the desired contextual focus, thereby effectively suppressing irrelevant audio content while preserving and/or emphasizing contextually relevant sounds for audio output.

The audio signal processing system 100 may also determine a probability score for the one or more contextual audio classifications 109. For example, the probability score may be calculated using a softmax function or another probability score technique that is applied to an output layer of the neural network model 110. A probability score may be a normalized probability value for a particular contextual audio classification of the one or more contextual audio classifications 109. Probability values may range from 0 to 1, where a higher value indicates a greater likelihood of a particular contextual audio classification being a correct context prediction for the audio stream 104. Additionally, responsive to the probability score satisfying a defined probability threshold, the audio signal processing system 100 may adapt gain associated with the audio stream 104 based on the one or more contextual audio classifications 109.

The defined probability threshold may refer to a predetermined numerical value or range of values that serves as a decision boundary for triggering utilization of the one or more contextual audio classifications 109 by the automixer 112 for adapting gain of the audio stream 104. In some examples, the responsive to the probability score satisfying a defined probability threshold, the audio signal processing system 100 may control a noise adaptive threshold, a gating decision, and/or control a degree of panning associated with the audio stream 104 based on the one or more contextual audio classifications 109.

The context-specific mixed audio stream 116 may be a contextualized version of the audio stream 104 that is generated by the automixer 112 by processing the audio stream 104 based on the one or more contextual audio classifications 109 and/or one or more other automatic microphone mixer parameters of the automixer 112. For example, the context-specific mixed audio stream 116 may represent an optimized version of the audio stream 104 that is tailored to the specific context identified by the one or more contextual audio classifications 109. The context-specific mixed audio stream 116 may be formatted as a digital audio signal. Alternatively, the context-specific mixed audio stream 116 may be formatted as an analog audio signal.

The context-specific mixed audio stream 116 may include one or more audio channels based on a desired output configuration (e.g., mono, stereo, multi-channel surround sound, etc.). In some examples, the context-specific mixed audio stream 116 may also include metadata that describes the applied processing via the automixer 112 and/or contextual information associated with the one or more contextual audio classifications 109. In some examples, the context-specific mixed audio stream 116 may be stored in one or more memory buffers for further processing or output via the pre-processing 118, the neural network model 120, and/or the post-processing 122. Additionally, the context-specific nature of the context-specific mixed audio stream 116 may allow for more targeted and/or efficient subsequent processing via the pre-processing 118, the neural network model 120, and/or the post-processing 122 to further improve the overall quality and relevance of the isolated audio 106.

In some examples, the pre-processing 118 may enhance the context-specific mixed audio stream 116 via one or more digital signal processing techniques such as dynamic range compression, spectral balancing, spatial audio rendering, etc. In some examples, the context-specific mixed audio stream 116 may be utilized as an intermediate output for the audio signal processing system 100 that reflects an understanding and/or adaptation of the audio signal processing system 100 to the detected audio context for the audio stream 104. Further, the context-specific mixed audio stream 116 may emphasize certain audio elements while de-emphasizing others based on predicted contextual relevance. For instance, in a sports broadcast context, the context-specific mixed audio stream 116 may emphasize sounds of player movements and/or game actions while reducing emphasis of crowd noise or undesirable background sounds.

The audio signal processing system 100 may also generate an audio feature set 117 for the context-specific mixed audio stream 116. The audio feature set 117 may be a model input audio feature set for the neural network model 120 utilized by the audio signal processing system 100 for providing audio isolation, denoising, speech removal, and/or other filtering of sound with respect to the context-specific mixed audio stream 116.

The audio feature set 107 and the audio feature set 117 may differ in feature composition, dimensionality, and/or optimization targets. For instance, the audio feature set 107 may be configured for contextual audio classification and may emphasize features that enable identification of audio context, audio event types, and/or environmental characteristics. Additionally, the audio feature set 107 may prioritize temporal features, spectral envelope characteristics, and pattern recognition features that enable the neural network model 110 to distinguish between different classes of audio.

In contrast, the audio feature set 117 may be configured for audio isolation mask generation and may emphasize features that enable separation and isolation of specific audio components from the context-specific mixed audio stream 116. For instance, the audio feature set 117 may prioritize fine-grained spectral features, phase information, and/or time-frequency representations that enable the neural network model 120 to generate accurate audio isolation masks for denoising, speech removal, and signal of interest extraction. Additionally, the audio feature set 117 may be derived from the context-specific mixed audio stream 116, where the context-specific mixed audio stream 116 may be already been processed based on the one or more contextual audio classifications 109. As such, the audio feature set 117 may include features that reflect the contextual processing applied by the automixer 112. The audio feature set 107 may also utilize a broader frequency range as compared to the audio feature set 117 to capture overall audio context. For instance, the audio feature set 117 may utilize a more focused frequency range as compared to the audio feature set 107, where the frequency range is optimized for the specific isolation task indicated by the one or more contextual audio classifications 109. The audio feature set 107 and the audio feature set 117 may also differ in feature extraction parameters such as window size, hop length, and/or frequency resolution based on the differing feature extraction criteria for contextual classification versus audio isolation mask generation.

In some examples, the audio feature set 117 includes one or more audio features for the context-specific mixed audio stream 116. Additionally, the audio feature set 107 may represent physical features and/or perceptual features related to the context-specific mixed audio stream 116. For instance, the audio feature set 107 may comprise: one or more: audio spectrum features, magnitude features, phase features, pitch features, harmonic features, MFCC features, performance features, performance sequencer features, tempo features, time signature features, and/or other types of features associated with the context-specific mixed audio stream 116.

The audio spectrum features represent physical features of the context-specific mixed audio stream 116 such as frequency characteristics and/or distribution of energy measurements with respect to the context-specific mixed audio stream 116. The magnitude features may represent physical features of the context-specific mixed audio stream 116 such as magnitude measurements with respect to the context-specific mixed audio stream 116. The phase features may represent physical features of the context-specific mixed audio stream 116 such as phase measurements with respect to the context-specific mixed audio stream 116. The pitch features may represent perceptual features of the context-specific mixed audio stream 116 such as frequency characteristics related to pitch for the context-specific mixed audio stream 116. The harmonic features may represent perceptual features of the context-specific mixed audio stream 116 such as frequency characteristics related to harmonics for the context-specific mixed audio stream 116.

The MFCC features may represent physical features of the context-specific mixed audio stream 116 such as MFCC measurements with respect to the context-specific mixed audio stream 116. The MFCC measurements may be extracted based on windowing operations, digital transformations, and/or warping of frequencies on a Mel frequency scale with respect to the context-specific mixed audio stream 116.

The performance features may represent perceptual features of the context-specific mixed audio stream 116 such as audio characteristics related to performance of the context-specific mixed audio stream 116. In some examples, the performance features may be obtained via one or more audio analyzers that analyze performance of the context-specific mixed audio stream 116. The performance sequencer features may represent perceptual features of the context-specific mixed audio stream 116 such as audio characteristics related to performance of the context-specific mixed audio stream 116 as determined by one or more audio sequencers that analyze characteristics of the context-specific mixed audio stream 116.

The tempo features may represent perceptual features of the context-specific mixed audio stream 116 such as beats per minute characteristics related to tempo for the context-specific mixed audio stream 116. The time signature features may represent perceptual features of the context-specific mixed audio stream 116 such as beats per musical measure characteristics related to a time signature for the context-specific mixed audio stream 116.

In some examples, the audio signal processing system 100 applies pre-processing 118 to the context-specific mixed audio stream 116. The pre-processing 118 may generate one or more portions of the audio feature set 117. For example, the pre-processing 118 may perform one or more feature extraction techniques with respect to the context-specific mixed audio stream 116 to generate one or more portions of the audio feature set 117.

The audio feature set 117 may be input to the neural network model 120. The audio signal processing system 100 may include the neural network model 120. Alternatively, the audio signal processing system 100 may be communicatively coupled the neural network model 120. The neural network model 120 may be configured to determine at least one audio isolation mask 119 associated with the context-specific mixed audio stream 116.

The neural network model 120 may be configured to process the audio feature set 117 and generate an audio isolation mask 119 associated with the context-specific mixed audio stream 116. For example, the neural network model 120 may be utilized to separate and/or isolate specific audio components from the context-specific mixed audio stream 116. The neural network model 120 may be implemented as a deep learning architecture specialized for audio source separation and/or mask estimation processing. For example, the neural network model 120 model may include a U-Net structure, a deep clustering network, or a transformer-based model. The structure of the neural network model 120 may consist of multiple layers designed to capture local patterns and/or global patterns in the audio feature set 117 with specific components tailored to the mask generation task associated with the audio isolation mask 119.

In some examples, the neural network model 120 may utilize optimized machine learning frameworks and/or machine learning libraries to enable the for the audio source separation and/or mask estimation processing. Computations of the neural network model 120 model may also leverage hardware acceleration techniques, such as GPU or TPU processing, to achieve real-time or near-real-time performance benchmarks for the neural network model 120. The architecture, weights, and/or other parameters of the neural network model 120 may be stored in memory. In some examples, the neural network model 120 may execute inference operations via processor or specialized neural processing units of the audio signal processing system 100.

The neural network model 120 may process the audio feature set 117 to generate the audio isolation mask 119. In an example, the audio isolation mask 119 includes a set of scaling values such as a set of time-frequency bin-wise scaling factors. In some examples, the audio isolation mask 119 may be applied to a spectrogram or wavelet representation of the context-specific mixed audio stream 116 to isolate or enhance specific audio components. Generation of the audio isolation mask 119 may also include source embedding, clustering, and/or direct regression of mask values.

The neural network model 110 and the neural network model 120 may share the same underlying neural network architecture to increase computational efficiency for the audio signal processing system 100. For example, by utilizing the same underlying neural network architecture for the neural network model 110 and the neural network model 120, the audio signal processing system 100 may leverage a single trained model for both contextual audio classification and audio isolation tasks. The shared underlying neural network architecture may also include various components such as convolutional layers, recurrent layers, and/or hybrid structures where the specific configuration is optimized to effectively handle both contextual classification and isolation tasks. In other examples, the neural network model 110 may include a different neural network architecture than the neural network model 120

Differentiation between the neural network model 110 and the neural network model 120 may occur in a post-processing stage where output masks respectively generated by the neural network model 110 and the neural network model 120 are customized for their specific purposes. For example, post-processing applied to output generated by the neural network model 110 may be tailored to optimize performance for the automixer 112. Conversely, post-processing applied to output generated by the neural network model 120 may be tailored for audio isolation. As such, the audio signal processing system 100 may optimally enable computational resource utilization and task-specific optimization. In some examples, the post-processing techniques applied to output of the neural network model 110 and the neural network model 120 may be dynamically adjusted based on current processing requirements, system resources, and/or user-defined parameters for the audio signal processing system 100 to enable flexible adaptation to different audio processing tasks.

The audio isolation mask 119 output by the neural network model 120 may be utilized by the post-processing 122 to further refine specific audio components of the context-specific mixed audio stream 116. As such, the isolated audio 106 provided by the audio signal processing system 100 may include optimized and/or filtered isolated audio that focuses on desired sound sources or events while suppressing unwanted audio elements of the audio stream 104. In some examples, the neural network model 120 may utilize multi-task learning to simultaneously generate multiple audio isolation masks for different audio components of the context-specific mixed audio stream 116. The neural network model 120 may also include an attention mechanism or another machine learning optimization technique to improve an ability of the neural network model 120 to focus on specific audio elements based on contextual cues and/or user-defined criteria.

The at least one audio isolation mask 119 may include: a denoiser mask, a speech removal mask, a signal of interest mask, and/or another type of audio mask associated with the context-specific mixed audio stream 116. For example, the neural network model 120 may determine a denoiser mask, a speech removal mask, and/or a signal of interest mask for the one or more arena sound microphone signals. The neural network model 120 may also determine a denoiser mask for the commentator microphone signal and/or reference microphone signal.

An audio isolation mask may be a neural network mask that isolates one or audio portions of the context-specific mixed audio stream 116 with respect to one or more other audio portions of the context-specific mixed audio stream 116. A denoiser mask may be a neural network mask that is utilized to remove undesirable noise from the context-specific mixed audio stream 116. A speech removal mask may be a neural network mask that is utilized to remove undesirable speech from the context-specific mixed audio stream 116. A signal of interest mask may be a neural network mask that is utilized to isolate one or more signals of interest from the context-specific mixed audio stream 116. In some examples, a signal of interest may include sporting event audio such as voice audio related to an athlete speaking to a coach and/or other non-speech sporting event noises such as a squeak of shoes worn by the athlete, bouncing of a basketball on a basketball court, the “swish” of a basketball passing through a net, and the like.

The audio signal processing system 100 may apply the at least one audio isolation mask 119 to the context-specific mixed audio stream 116 to generate the isolated audio 106. The isolated audio 106 may include: an isolated commentator's voice, isolated game sounds (e.g., a squeak of shoes worn by the athlete, bouncing of a basketball on a basketball court, etc.), an isolated referee's voice, and/or other isolated arena audio related to the arena environment. The isolated audio 106 may be output via one or more audio output devices. In some examples, the isolated audio 106 may be utilized as speech reinforcement and/or broadcast audio related to arena environment. The isolated audio 106 may also be correlated with a target video stream associated with the arena environment (e.g., a video stream associated with a sporting event, etc.).

In some examples, the isolated audio 106 may be mono audio. Alternatively, the isolated audio 106 may be spatial audio. For spatial audio implementations, the audio stream 104 received by the audio signal processing system 100 may include multiple channels and multiple audio isolation masks may be accordingly created. The multiple channels may also be designated to create a spatial audio sound field (e.g., stereo, 5.1 surround sound, Atmos® surround sound, etc.) for the arena environment.

Beam steering associated with at least one capture device may be performed based on the audio isolation mask 119. For example, a microphone array may be configured to steer respective beamforming lobes of a plurality of beamforming lobes toward a desired location and/or angle within an audio environment based on the audio isolation mask 119. The at least one audio isolation mask 119 may also be utilized to determine a direction for steering one or more beamformed lobes for one or more capture devices to improve signal-to-noise ratio (SNR) for audio signals.

To optimize beam steering, two or more crowd canceller operations may be performed with respect to two or more beamformed lobes steered in different directions. In some examples, a beamformed lobe with highest SNR may be determined as closer to a desired sound (and/or further away from an undesired sound). At a next iteration for beam steering, the delta in steering directions may be unchanged and beam steering may be centered with respect to the direction of the higher SNR signal from the previous iteration for beam steering. As such, one or more beamformed lobes may be steered over time to optimize SNR.

In some examples, a shape of a beamforming lobe may be modified based on the audio isolation mask 119. For instance, the audio isolation mask 119 may provide information regarding a spatial distribution of a desired audio source to enable a beamforming lobe to be adaptively reshaped for improved audio capture for the desired audio source while suppressing unwanted noise. Reshaping of a beamforming lobe may include adjusting beamforming lobe parameters such as width, direction, and/or side lobe suppression of a beamforming pattern to optimize a signal-to-noise ratio for the beamforming lobe. A shape of a beamforming lobe may be a rounded shape to provide a wider beam for capturing audio, an elongated shape to provide a more directed beam for capturing audio, or another type of shape to optimally capture audio associated with one or more audio sources.

In some examples, the at least one audio isolation mask 119 may be utilized to control selection of an audio channel associated with desirable audio. The desirable audio may refer to audio content that is intended to be preserved, emphasized, and/or isolated within an audio stream. The desirable audio may be isolated audio such as, but not limited to, an isolated commentator's voice, isolated game sounds (e.g., a squeak of shoes worn by the athlete, bouncing of a basketball on a basketball court, etc.), an isolated referee's voice, and/or other isolated arena audio related to the arena environment. In some examples, the audio signal processing system 100 may initiate selection of an audio channel associated with desirable audio based on the audio isolation mask 119. The audio channel may be selected from a plurality of audio channels associated with an audio mixer.

The audio signal processing system 100 may also apply post-processing 122 to the at least one audio isolation mask 119 and/or other data provided by the neural network model 120 to generate the isolated audio 106. The audio signal processing system 100 may apply the post-processing 122 to the isolated audio 106 to generate output data. The output data may be generated for an output device. For example, the output device may be an audio mixer device, a DSP processing device, a smartphone, a tablet computer, a laptop, a personal computer, an audio workstation device, a wearable device, an augmented reality device, a virtual reality device, a broadcasting device, a recording device, a microphone, headphones, earphones, speakers, a haptic device, or another type of output device. Additionally, the output data may include: an audio stream, a video stream, broadcast audio, broadcast video, speech reinforcement audio, a control signal, visual data for rendering via an electronic interface, training data for one or more machine learning models, and/or other output data.

In some examples, the audio signal processing system 100 receives one or more user audio isolation control parameters 130 via an electronic interface of a user device. The one or more user audio isolation control parameters 130 may be one or more parameters provided via a user interface that control fine-tuning of the audio isolation process within the audio signal processing system 100. The one or more user audio isolation control parameters 130 may control an intensity, smoothing, a dry/wet audio affect, and/or other audio isolation parameters for isolating audio associated with the isolated audio 106. The user audio isolation control parameters 130 may be accessed through a graphical user interface, providing intuitive controls for users to shape the audio output according to their preferences or the requirements of a particular audio environment. The user device may be a smartphone, a tablet computer, a laptop, a personal computer, an audio workstation device, a wearable device, an augmented reality device, a virtual reality device, or another type of user device that includes one or more displays. The one or more user audio isolation control parameters 130 may be utilized by the neural network model 110, the neural network model 120, and/or the post-processing 122 to further improve quality and/or control audio characteristics of the isolated audio 106.

The audio signal processing system 100 may also apply the one or more user audio isolation control parameters 130 to the audio isolation mask 119 to generate a user-modified audio isolation mask. To enable generation of a user-modified audio isolation mask, a user may control audio isolation associated with the audio stream 104 by determining priority of a goal of the dereverberation. For example, a goal may be to prioritize speech quality, balance, or prioritize removing dereverberation associated with the audio stream 104. As such, the isolated audio 106 may be generated based on the at least one audio isolation mask 119 and the one or more user audio isolation control parameters 130.

The post-processing 122 may utilize the one or more user audio isolation control parameters 130 to control an amount and/or ballistics of noise cancellation related to the at least one audio isolation mask 119. In some examples, the one or more user audio isolation control parameters 130 may be generated via one or more user-controlled elements of the electronic interface. The one or more user-controlled elements may also utilize a set of levels (e.g., low, med, high) to control an amount and/or ballistics of noise cancellation. Alternatively, the one or more user-controlled elements may utilize a dynamic user interface element (e.g., a continuous slider) to control an amount and/or ballistics of noise cancellation.

The dynamic user interface element may allow a user (e.g., an audio engineer) to achieve improved sound isolation to create a soundtrack portion (e.g., a ‘game sounds FX’ track) of an audio mix. The soundtrack portion may allow punctuation of game sounds or other sounds in an arena environment. The soundtrack portion may also isolate sound with minimal aggression to create a more naturally sounding audio track that may be listened to separate from an audio mixture context while increasing game sound SNR for output audio.

The one or more user-controlled elements may also enable control of an intensity of noise suppression. For example, at higher values, more sound from a crowd may be attenuated. A value may also be set to reduce an amount of suppression from, up to a particular point where no processing is audible. The noise suppression may utilize magnitude mask post processing such as performing mask exponentiation to attenuate more (e.g., exponentiation x\hat{ }(greater than 1) or attenuate less (e.g., exponentiation x\hat{ }(less than 1) frequency bands that the neural network model 120 have deemed crowd noise to be removed.

The one or more user audio isolation control parameters 130 may also enable control of a rate at which noise (e.g., crowd noise) will be suppressed after an event sound detected. For example, if a noise such as a basketball dribble is detected, the audio signal processing system 100 may be configured with a higher release control to stop suppressing crowd noise for a longer time to let more of the dribbling sound enter an audio channel. The release control may include controlling a maximum descent rate (e.g., in dB/s) that an attenuation value is allowed to fall, while specifying a different maximum ascent rate (e.g., in dB/s) that an attenuation value is allowed to rise. As such, by providing an ascent time that is greater than a descent time, a user may tune (e.g., dial in) the level of audio that is passing through temporally and/or may tune the audio to achieve a desired level of ‘naturalness’. The release control may also include controlling a maximum descent/ascent rate to an absolute descent/ascent rate by allowing the ascent rate to be increased or decreased by a predetermined amount.

An arena environment may define a playing region, a spectator region, and a noise source region. Additionally, the audio signal processing system 100 may generate the isolated audio 106 for the playing region, the spectator region, and/or the noise source region based on the audio isolation mask 119 and/or the one or more user audio isolation control parameters 130.

In some examples, the isolated audio 106 may be provided to and/or utilized by an audio mixer. The audio mixer may generate a spatial audio field for the arena environment. Additionally, the audio mixer may mix one or more portions of the isolated audio 106 with context to desired game sounds or other desired arena sounds. In some examples, the isolated audio 106 may be provided as an input to the audio mixer such that audio being mixed for the arena environment is optimized to desired game sounds or other desired arena sounds.

Rather than utilizing the neural network model 110 and the neural network model 120, the audio signal processing system 100 may alternatively utilize an audio mixer configured to generate mixed audio output and/or at least one audio isolation mask associated with the audio stream 104 based on an isolated audio quality determination associated with the audio stream 104. The at least one audio isolation mask may then be applied to the mixed audio output to generate the isolated audio 106.

The audio signal processing system 100 may also process multiple audio channels to allow the multiple audio channels to be mixed together. In some examples, the audio signal processing system 100 may generate mixed isolated audio based on the isolated audio 106 and different isolated audio associated with the arena environment. The different isolated audio may be associated with a different audio channel than the isolated audio 106. Additionally, the audio signal processing system 100 may generate the output data for the output device based at least in part on the mixed isolated audio.

The audio signal processing system 100 may also be utilized as a side-chain system where audio channels that control mixing decisions for the arena environment are processed by the audio signal processing system 100. Additionally, the resulting control signals can determine which audio signals to select for isolated audio purposes via the audio signal processing system 100. In some examples, the audio signal processing system 100 may receive a first audio channel stream via a first capture device positioned within a first audio capture area of the environment. The first audio capture area may be a playing region, a spectator region, or a noise source region for the arena environment. Additionally, the audio signal processing system 100 may receive a second audio channel stream via a second capture device positioned within a second audio capture area of the environment. The second audio capture area may be a playing region, a spectator region, or a noise source region for the arena environment.

The audio signal processing system 100 may also generate a first audio feature set for the first audio channel stream and/or generate a second audio feature set for the second audio channel stream. Additionally, the audio signal processing system 100 may input the first audio feature set to a first neural network model to generate a first mixing control signal. The audio signal processing system 100 may also input the second audio feature set to a second neural network model to generate a second mixing control signal. In some examples, the audio signal processing system 100 may select the audio stream 104 from a plurality of audio streams based on the first mixing control signal and the second mixing control signal. In some examples, the audio signal processing system 100 may select the audio stream 104 via an audio mixer device.

It is to be appreciated that, the audio signal processing system 100 and/or one or more other aspects disclosed herein may employ fewer of computing resources when compared to traditional audio processing systems that are used for digital signal processing. The audio signal processing system 100 and/or one or more other aspects disclosed herein may also be configured to deploy a smaller number of memory resources allocated to audio isolation, dereverberation, denoising, and/or other audio filtering for an audio signal sample such as, for example, one or more portions of the audio stream 104. In still other examples, the audio signal processing system 100 and/or one or more other aspects disclosed herein may be configured to improve processing speed of audio isolation operations, dereverberation operations, denoising operations, and/or audio filtering operations.

The audio signal processing system 100 and/or one or more other aspects disclosed herein may also be configured to reduce a number of computational resources associated with applying machine learning models such as, for example, the neural network model 110 and/or the neural network model 120, to the task of audio isolation, dereverberation, denoising, and/or other audio filtering. These improvements enable, in some examples, for an improved audio processing systems to be deployed in an arena system or other hardware/software configurations associated with an arena environment where processing and memory resources are limited, and/or where processing speed and efficiency is important.

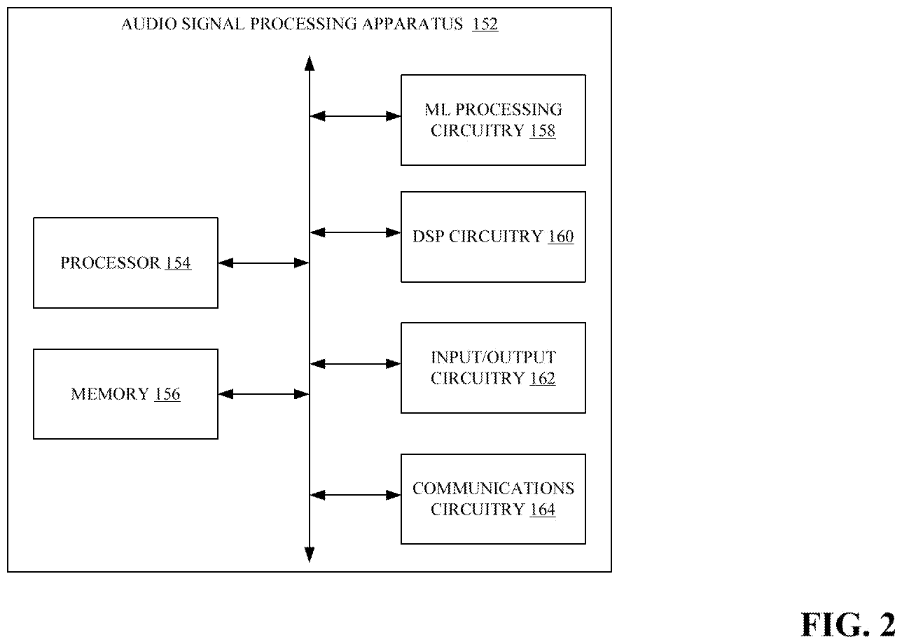

FIG. 2 illustrates an example audio signal processing apparatus 151 configured in accordance with one or more embodiments of the present disclosure. The audio signal processing apparatus 151 may be configured to perform one or more techniques described in FIG. 1 and/or one or more other techniques described herein. In one or more embodiments, the audio signal processing apparatus 151 may be embedded in the audio signal processing system 100.

In some cases, the audio signal processing apparatus 151 may be a computing system communicatively coupled with, and configured to control, one or more circuit modules associated with audio processing. For example, the audio signal processing apparatus 151 may be a computing system and/or a computing system communicatively coupled with one or more circuit modules related to audio processing. The audio signal processing apparatus 151 may comprise or otherwise be in communication with a processor 153, a memory 156, ML processing circuitry 158, DSP processing circuitry 160, input/output circuitry 162, and/or communications circuitry 164. In some examples, the processor 153 (which may comprise multiple or co-processors or any other processing circuitry associated with the processor) may be in communication with the memory 156.

The memory 156 may comprise non-transitory memory circuitry and may comprise one or more volatile and/or non-volatile memories. In some examples, the memory 156 may be an electronic storage device (e.g., a computer readable storage medium) configured to store data that may be retrievable by the processor 153. In some examples, the data stored in the memory 156 may comprise radio frequency signal data, audio data, stereo audio signal data, mono audio signal data, or the like, for enabling the apparatus to carry out various functions or methods in accordance with embodiments of the present disclosure, described herein.

In some examples, the processor 153 may be embodied in a number of different ways. For example, the processor 153 may be embodied as one or more of various hardware processing means such as a central processing unit (CPU), a microprocessor, a coprocessor, a digital signal processor (DSP), an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 153 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 153 may comprise one or more processing cores configured to perform independently. A multi-core processor may enable multiprocessing within a single physical package. Additionally or alternatively, the processor 153 may comprise one or more processors configured in tandem via the bus to enable independent execution of instructions, pipelining, and/or multithreading.

In some examples, the processor 153 may be configured to execute instructions, such as computer program code or instructions, stored in the memory 156 or otherwise accessible to the processor 153. Alternatively or additionally, the processor 153 may be configured to execute hard-coded functionality. As such, whether configured by hardware or software instructions, or by a combination thereof, the processor 153 may represent a computing entity (e.g., physically embodied in circuitry) configured to perform operations according to an embodiment of the present disclosure described herein. For example, when the processor 153 is embodied as an CPU, DSP, ARM, FPGA, ASIC, or similar, the processor may be configured as hardware for conducting the operations of an embodiment of the disclosure described herein. Alternatively, when the processor 153 is embodied to execute software or computer program instructions, the instructions may specifically configure the processor 153 to perform the algorithms and/or operations described herein when the instructions are executed. However, in some cases, the processor 153 may be a processor of a device specifically configured to employ an embodiment of the present disclosure by further configuration of the processor using instructions for performing the algorithms and/or operations described herein. The processor 153 may further comprise a clock, an arithmetic logic unit (ALU) and logic gates configured to support operation of the processor 153, among other things.

In some examples, the audio signal processing apparatus 151 may comprise the ML processing circuitry 158. The ML processing circuitry 158 may be any means embodied in either hardware or a combination of hardware and software that is configured to perform one or more functions disclosed herein related to machine learning. In some examples, the ML processing circuitry 158 may perform one or more functions associated with the neural network model 110, the neural network model 120, and/or one or more other machine learning models disclosed herein related to machine learning. In some examples, the audio signal processing apparatus 151 may comprise the DSP processing circuitry 160. The DSP processing circuitry 160 may be any means embodied in either hardware or a combination of hardware and software that is configured to perform one or more functions disclosed herein related to digital signal processing. In some examples, the DSP processing circuitry 160 may perform one or more operations associated with the pre-processing 108, the pre-processing 118, and/or the post-processing 122. In some examples, the DSP processing circuitry 160 may perform one or more operations associated with applying computed masks and/or filters to the context-specific mixed audio stream 116 to generate the isolated audio 106.

In some examples, the audio signal processing apparatus 151 may comprise the input/output circuitry 162 that may, in turn, be in communication with processor 153 to provide output to the user and, in some examples, to receive an indication of a user input. The input/output circuitry 162 may comprise a user interface and may comprise a display. In some examples, the input/output circuitry 162 may also comprise a keyboard, a touch screen, touch areas, soft keys, buttons, knobs, or other input/output mechanisms.

In some examples, the audio signal processing apparatus 151 may comprise the communications circuitry 164. The communications circuitry 164 may be any means embodied in either hardware or a combination of hardware and software that is configured to receive and/or transmit data from/to a network and/or any other device or module in communication with the audio signal processing apparatus 151. In this regard, the communications circuitry 164 may comprise, for example, an antennae or one or more other communication devices for enabling communications with a wired or wireless communication network. For example, the communications circuitry 164 may comprise antennae, one or more network interface cards, buses, switches, routers, modems, and supporting hardware and/or software, or any other device suitable for enabling communications via a network. Additionally or alternatively, the communications circuitry 164 may comprise the circuitry for interacting with the antenna/antennae to cause transmission of signals via the antenna/antennae or to handle receipt of signals received via the antenna/antennae.

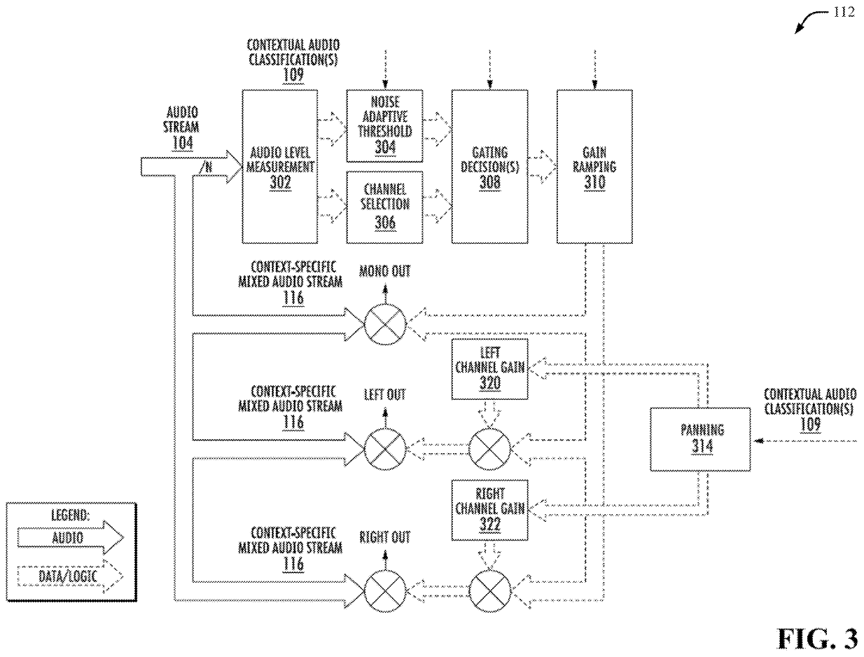

FIG. 3 illustrates an example automixer 112, according to embodiments of the present disclosure. The automixer 112 includes digital signal processing functionality associated with audio level measurement 302, a noise adaptive threshold 304, channel selection 306, one or more gating decisions 308, gain ramping 310, and/or panning 314. The automixer 112 may generate the context-specific mixed audio stream 116 for the audio stream 104 based on the one or more contextual audio classifications 109. For example, the automixer 112 may utilize the one or more contextual audio classifications 109 to guide mixing decisions for the audio stream 104.

The automixer 112 may utilize the one or more contextual audio classifications 109 as control signals to guide mixing decisions for the audio stream 104. The intensity of the control signals may be adjustable to enable varying degrees of influence with respect to the mixing process. For instance, when a lower intensity is applied to the control signal, the automixer 112 may include a broader range of sounds in the context-specific mixed audio stream 116 (e.g. to not solely focus on the target sounds identified by the contextual audio classifications 109). As such, a mixed audio output that balances an actual audio event being monitored and an idealized version of the event (e.g., an idealized version of the event as if it were occurring in an anechoic chamber, etc.) may be provided.

The automixer 112 may also modify the noise adaptive threshold 304, the one or more gating decisions 308, the gain ramping 310, and/or panning 314 based on the contextual audio classifications 109. In some examples, the audio signal processing system 100 may enable user control over the noise adaptive threshold 304, the one or more gating decisions 308, the gain ramping 310, and/or panning 314, thereby enabling fine-tuning of the gating decisions and/or other mixing aspects related to the automixer 112.

The automixer 112 may also adjust and/or combine multiple audio inputs or channels of the audio stream 104 based on the one or more contextual audio classifications 109 to optimize the context-specific mixed audio stream 116 for predicted audio context. In some examples, the automixer 112 may adapt gain associated with the audio stream 104 via the gain ramping 310 based on the one or more contextual audio classifications 109. The gain ramping 310 may include adjustment of the gain or amplitude of the audio stream 104 over time. The gain ramping 310 may smooth a transition between different gain levels of the audio stream 104 to avoid undesirable audible artifacts. The automixer 112 may also control the noise adaptive threshold 304 for the audio stream 104 based on the one or more contextual audio classifications 109.

The noise adaptive threshold 304 may be a dynamic noise level setting that is automatically adjusted based on the ambient noise conditions detected in the audio stream 104 to improve distinguishing between desired audio signals and background noise. In some examples, the noise adaptive threshold 304 may be a particular threshold value that is capable of being increased or decreased based on the one or more contextual audio classifications 109. The noise adaptive threshold 304 may enable the automixer 112 to improve the one or more gating decisions 308, thereby improving the overall clarity and signal-to-noise ratio of the context-specific mixed audio stream 116.

The automixer 112 may control the one or more gating decisions 308 for the audio stream 104 based on the one or more contextual audio classifications 109. The one or more gating decisions 308 may selectively activate or deactivate specific audio channels of the audio stream 104 based on predefined criteria such as signal level, audio channel priority, detected audio content, and/or the one or more contextual audio classifications 109. Additionally, the one or more gating decisions 308 may be utilized to reduce unwanted noise by allowing relevant audio portions of the audio stream 104 to pass through while attenuating or muting inactive or less important channels of the audio stream 104.

The automixer 112 may also control a degree of the panning 314 associated with the audio stream 104 based on the one or more contextual audio classifications 109. For example, the panning 314 may control an amount of left channel gain 320 and right channel gain 322 for a stereo mix version of the context-specific mixed audio stream 116. Additionally, the audio level measurement 302 of the automixer 112 may be utilized to computer a basic level measurement for the audio stream 104. The basic level measurement for the audio stream 103 may be utilized to additionally control the noise adaptive threshold 304 and/or the one or more gating decisions 308 for the audio stream 104.

In some examples, a mono mix version of the context-specific mixed audio stream 116 may be computed using the following equation:

$${mix [ n ]}_{mono} = {\sum }_{i = 0}^{C} {s}_{i} [ n ] * G ( {BLM}_{i} , {NAT}_{i} , {Gate}_{i} ) , n = 0 , 1 , 2 , …$$

where C corresponds to the number of channels, s corresponds to a signal of the audio stream 104, G corresponds to the gain, BLM corresponds to the audio level measurement 302, NAT corresponds to the noise adaptive threshold 304, and Gate corresponds to the one or more gating decisions 308.

In some examples, a stereo mix version of the context-specific mixed audio stream 116 may be computed using the following equations:

$${mix [ n ]}_{left} = {\sum }_{i = 0}^{C} {s}_{i} [ n ] * G ( {BLM}_{i} , {NAT}_{i} , {Gate}_{i} ) * {Pan}_{i , left} , n = 0 , 1 , 2 , …$$

$${mix [ n ]}_{right} = {\sum }_{i = 0}^{C} {s}_{i} [ n ] * G ( {BLM}_{i} , {NAT}_{i} , {Gate}_{i} ) * {Pan}_{i , right} , n = 0 , 1 , 2 , …$$

where C corresponds to the number of channels, s corresponds to a signal of the audio stream 104, G corresponds to the gain, BLM corresponds to the audio level measurement 302, NAT corresponds to the noise adaptive threshold 304, Gate corresponds to the one or more gating decisions 308, and Pan corresponds to the panning 314.

In some examples, the panning 314 may be computed using the following equation:

$$[ {Pan}_{left} , {Pan}_{r ight} ] = \{ \begin{matrix}1 , cos ( \frac{θ π}{2} ) , & where - 1 \leq θ \leq 0 \\ cos ( \frac{θ π}{2} ) , 1 , & where 0 \leq θ \leq + 1\end{matrix}$$

where Pan_{left} corresponds to panning for the left channel gain 320 and Pan_{right} corresponds to panning for the the right channel gain 322. In some examples, each channel may utilize a unique value of θ to determine the amount of left/right panning to be applied before mixing. A transfer function may also be used for 3D audio by accounting for global (x,y,z) coordinates of a listener and/or a source to provide automatically panning for known locations within the audio environment.

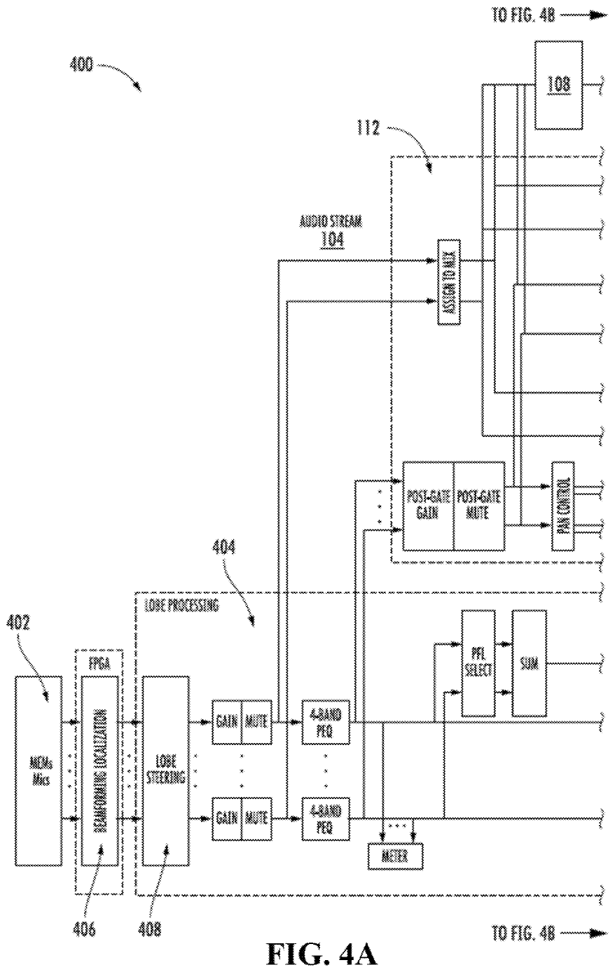

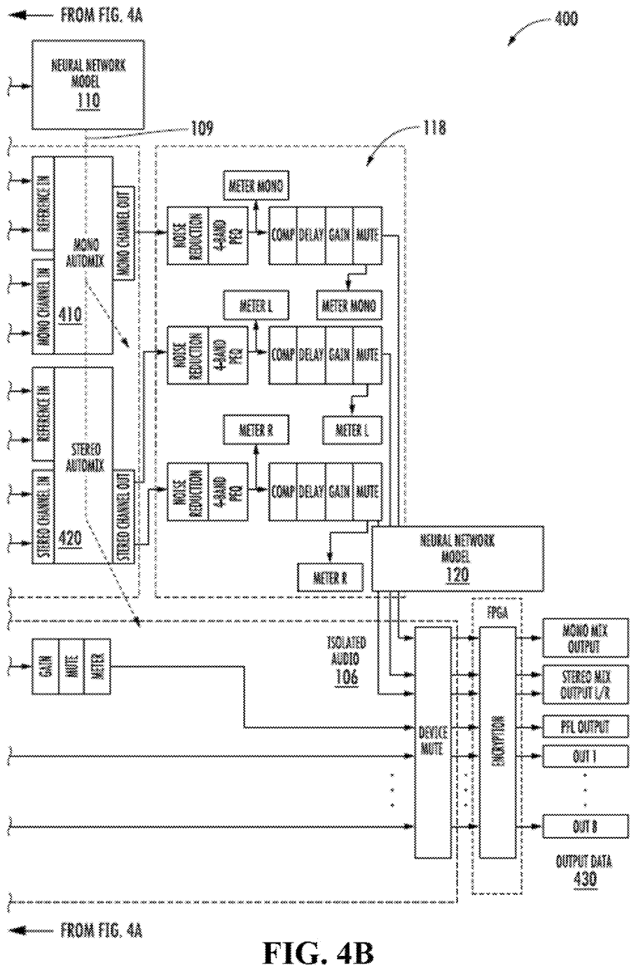

FIGS. 4A and 4B illustrate an audio signal processing system 400 that is configured to provide audio enhancement and optimization using contextual audio signal processing, according to embodiments of the present disclosure. In some examples, the audio signal processing system 400 may correspond to an embodiment of the audio signal processing system 100. As illustrated in 4A and 4B, the audio signal processing system 400 includes the automixer 112, the pre-processing 108, the pre-processing 118, the neural network model 110, and the neural network model 120. In some examples, a microphone array 402 may generate the audio stream 104. Additionally, lobe processing 404 associated with the microphone array 402 may be utilized to capture the audio stream 104 via one or more beamforming lobes of the microphone array 402. For example, the lobe processing 404 may include beamforming localization 406 and/or lobe steering 408 to facilitate capture of the audio stream 104 via one or more beamforming lobes of the microphone array 402.

The pre-processing 108 may generate the audio feature set 107 for the audio stream 104. Additionally, the audio feature set 107 may be provided as input to the neural network model 110 to generate the one or more contextual audio classifications 109 for the audio stream 104. The one or more contextual audio classifications 109 may be utilized to control functionality of the automixer 112. For example, the one or more contextual audio classifications 109 may be provided as a control signal to a mono automixer 410 of the automixer 112 in response to the audio stream 104 being formatted as a mono audio stream. Alternatively, the one or more contextual audio classifications 109 may be provided as a control signal to a stereo automixer 412 of the automixer 112 in response to the audio stream 104 being formatted as a stereo audio stream.

The mono automixer 410 and the stereo automixer 412 of the automixer 112 may employ different panning techniques to process the audio stream 104 based on a format of the audio stream 104. In some examples, the stereo automixer 412 may utilize gain-based panning where the gain of each channel is adjusted to achieve a desired stereo effect. For instance, a center pan may apply equal gain (e.g., 50%/50%) to both left and right channels, while a hard right pan may allocate all the gain (e.g., 0%/100%) to the right channel. The audio signal processing system 100 may also utilize a panning technique such as delay-based panning to introduce time delays between channels and create a stereo effect. For example, a center pan for delay-based panning may apply no delay (e.g., 0 ms/0 ms) to either channel, while a hard right pan may introduce a delay (e.g., 50 ms/0 ms) to create the perception of directionality. The audio signal processing system 100 may also utilize a gain-based panning technique and a delay-based panning techniques for enabling certain types of audio effects.

The context-specific mixed audio stream 116 for the audio stream 104 may be generated by the automixer 112 based at on the one or more contextual audio classifications 109. In some examples, the pre-processing 118 generates the audio feature set 117 for the context-specific mixed audio stream 116. Additionally, the audio feature set 117 may be provided as input to the neural network model 120 to generate an audio isolation mask associated with the context-specific mixed audio stream 116.

The pre-processing 118 may apply one or more digital signal processing techniques, such as noise reduction, a parametric equalizer, compression, delay, and/or gain, to the context-specific mixed audio stream 116 prior to generation of the audio feature set 117 to enable more accurate feature extraction for the neural network model 120. The isolated audio 106 may also be generated for the context-specific mixed audio stream 116 based on the audio isolation mask. In some examples, the audio signal processing system 400 may generate output data 430 for an output device based on the isolated audio.

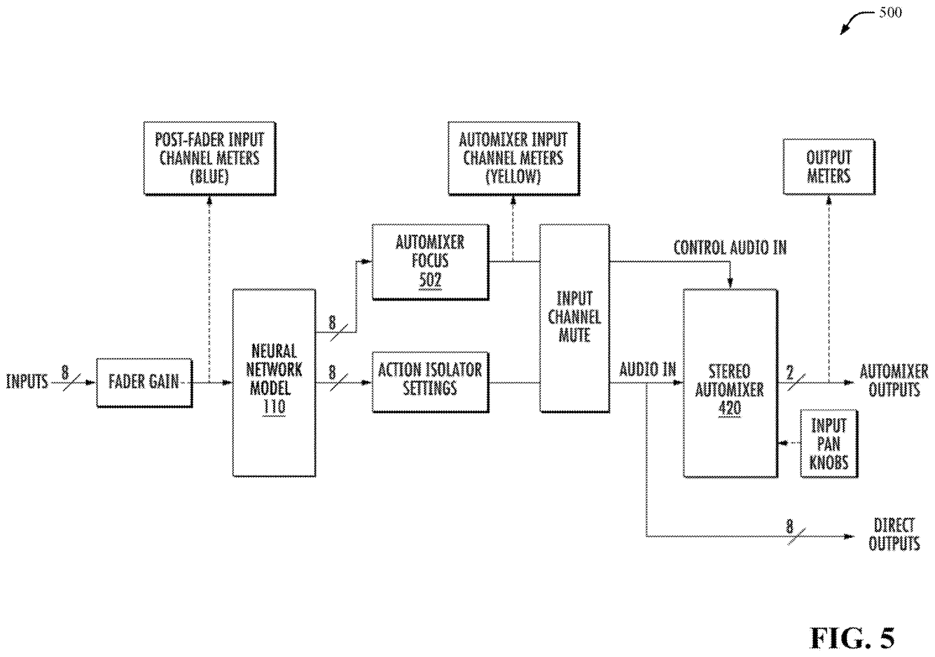

FIG. 5 illustrates an audio mixing system 500 that is configured to provide intelligent control of an automixer, according to embodiments of the present disclosure. The audio mixing system 500 includes the neural network model 110 and the stereo automixer 420.

In some examples, the stereo automixer 420 may apply gain to a plurality of input audio channels associated with the audio stream 104. Additionally, the stereo automixer 420 may combine the gain-adjusted signals into a two-channel output. The number of input audio channels may vary, and in some examples, may range from 8 to 16 channels. The stereo automixer 420 may also mix the input channels in a stereo configuration, utilizing panning controls for each input channel or by selectively routing inputs to one or both output channels in a dual-mono configuration.

The stereo automixer 420 may utilize a gating mechanism that activates or deactivates channels based on the presence and intensity of game-related audio content in each channel rather than relying solely on the overall captured audio levels. The gating process may be enabled by initially processing the audio through the neural network model 110 to isolate or enhance sports-related sounds while attenuating or removing non-sports audio components. The processed signals from the neural network model 110 may serve as control signals for the stereo automixer 420 to, for example, inform gating decisions of the stereo automixer 420. In some examples, a channel may be gated on based on presence of action content detected in the signals provided by the neural network model 110, while the output may consist of the original captured audio.

The audio signal processing system 100 may also incorporate automixer focus functionality 502 to refine the contextual audio classifications 109 for the audio stream 104. In some examples, the automixer focus functionality 502 may control the intensity of isolation applied in the control signals provided by the neural network model 110 to the stereo automixer 420. For instance, the automixer focus functionality 502 may enable the audio signal processing system 100 to adjust the degree to which the automixer 112 focuses on specific sounds identified by the contextual audio classifications 109.

By modulating the intensity of isolation in the control signals, the automixer focus functionality 502 may enable fine-tuned control over a degree to which the stereo automixer 420 adheres to the identified context-specific audio elements. As such, the automixer focus functionality 502 may enable more finely controlled mixing decisions, balancing the prominence of desired audio content (e.g., such as sports-related sounds) against the overall acoustic environment captured in the audio stream 104. In some examples, the automixer focus functionality 502 may serve as an intermediary layer between the contextual audio classifications 109 and the final mixing decisions, thereby providing an additional level of control and/or adaptability in the audio processing pipeline.

The degree of isolation applied to the two-channel output may be adjustable and may be controlled by user input or predefined settings. In an example where the stereo automixer 420 processes signals captured by a capture device (e.g., a microphone array) positioned in an arena environment to record game sounds in the arena environment, the resulting output may approximate the mix that a broadcast engineer desires to create by manually adjusting faders to activate channels closest to the game action. However, the stereo automixer 420 may provide the additional capability of enhancing the signal-to-noise ratio of sports-related sounds, thereby improving the clarity and focus of audio content of the output audio.

The stereo automixer 420 may be alternatively configured as a dual mixer. For example, two separate audio signal paths may provide independent automixes for each mix output. As such, two different mixes may be provided from the same set of inputs. In an example, a first mix output may be utilized for sound reinforcement and a second mix output may be utilized for a broadcast feed.

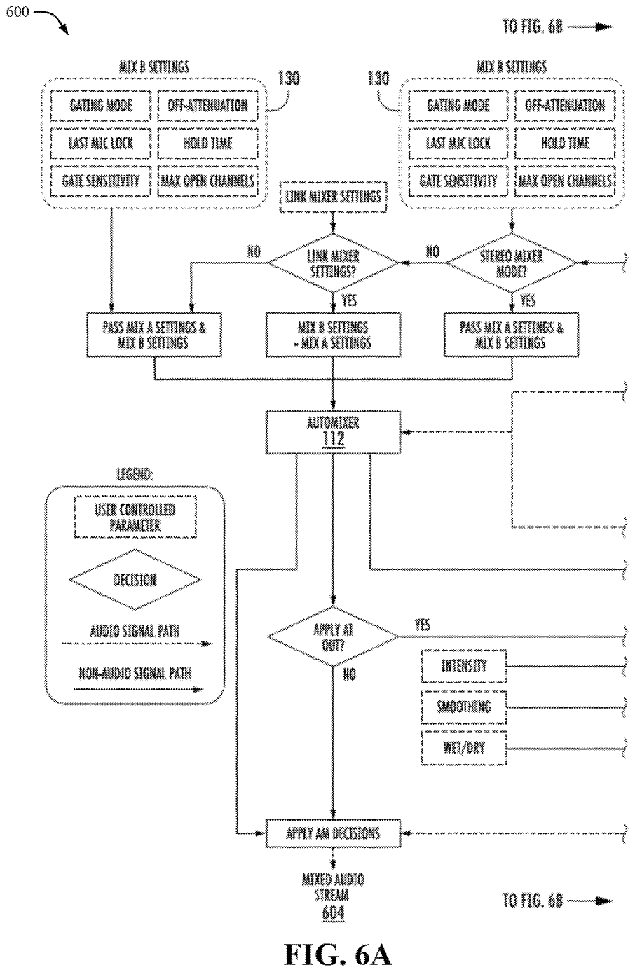

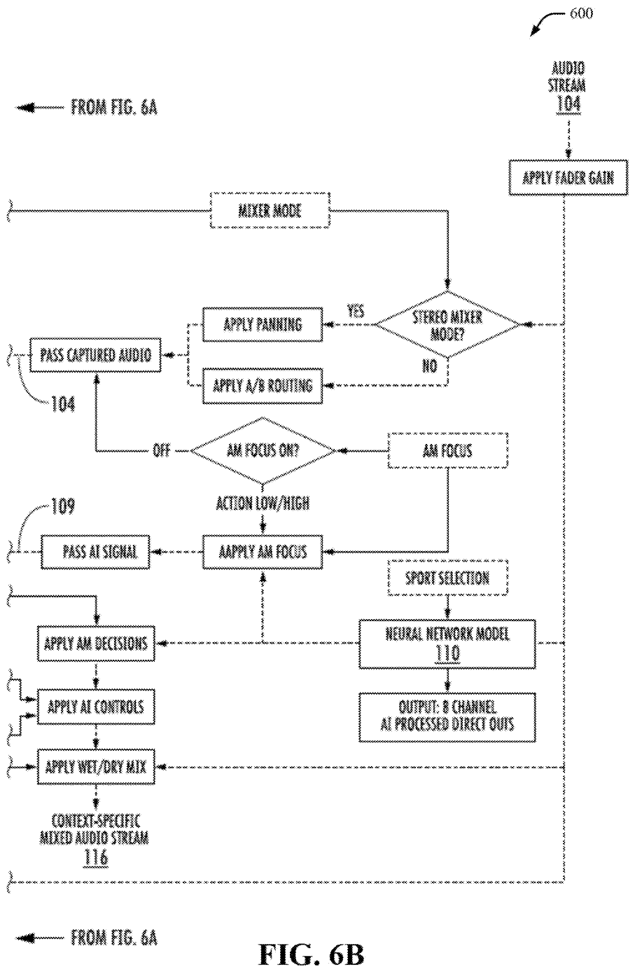

FIGS. 6A and 6B illustrate an example signal flow diagram 600, according to embodiments of the present disclosure. The signal flow diagram 600 may process the audio stream 104 through multiple digital signal processing stages and/or machine learning stages to produce the context-specific mixed audio stream 116. For example, the neural network model 110 may process a feature set associated with the audio stream 104 to determine the one or more contextual audio classifications 109. The audio stream 104 and the one or more contextual audio classifications 109 may be provided as input to the automixer 112.

Based on the one or more contextual audio classifications 109, the automixer 112 may generate the context-specific mixed audio stream 116 or a mixed audio stream 604. The mixed audio stream 604 may be a mixed version of the audio stream 104 that does not utilize context information (e.g., the one or more contextual audio classifications 109) associated with the audio stream 104 to for mixing. Additionally, the automixer 112 may utilize the one or more user audio isolation control parameters 130 to further optimize mixing settings for the automixer 112. As such, the signal flow diagram 600 may enable transformation of the audio stream 104 into an optimized audio stream associated with context-specific mixed audio.

The automixer 112 may be configured to generate either the context-specific mixed audio stream 116 or the mixed audio stream 604 based on mixing decisions related to applying artificial intelligence modeling to output. For example, the one or more contextual audio classifications 109 may be utilized to determine whether or not to apply AI-processed audio. In some examples, system latency may be utilized in real-time audio processing scenarios to determine whether or not to apply AI-processed audio. For instance, if a certain degree of processing delay is introduced by neural network model 110, the audio signal processing system 100 may generate the mixed audio stream 604 (e.g., which may not rely on the contextual audio classifications 109) to provide low-latency output. However, even in high-latency situations, the contextual audio classifications 109 may provide valuable input for automixer decisions by the automixer 112 to direct gain adjustments, noise threshold settings, and/or gating decisions. As such, the audio signal processing system 100 may dynamically balance these factors based on real-time processing requirements, processing capabilities, and/or desired output characteristics. The automixer 112 may also adapt processing based on both the contextual understanding of the audio content and the real-time constraints of the audio signal processing system 100 to provide optimal audio output quality across various types of operating conditions.

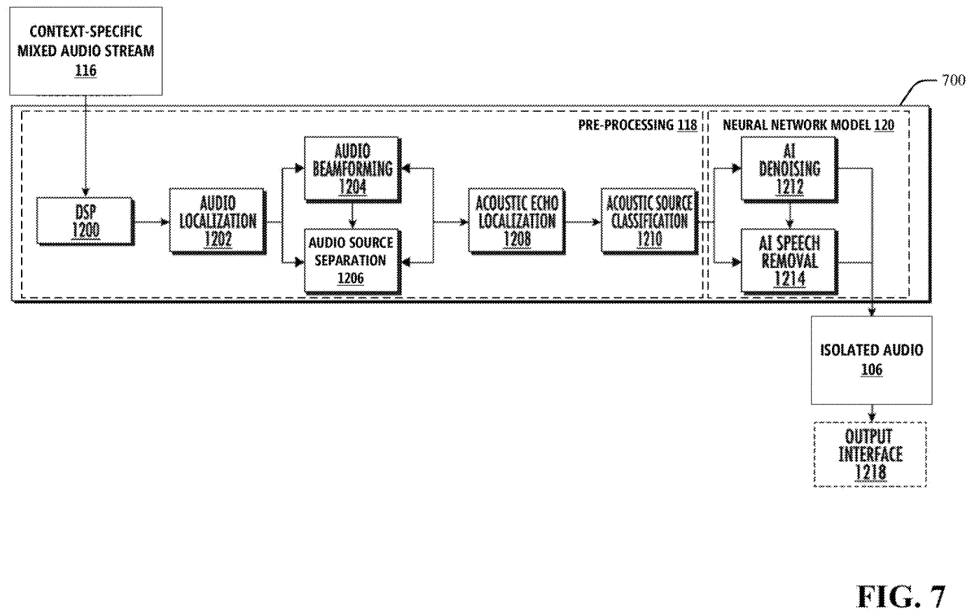

FIG. 7 illustrates an example audio signal processing subsystem 700, according to embodiments of the present disclosure. As depicted in FIG. 7, the audio signal processing subsystem 700 includes a DSP module 1200 that is configured to use sound wave processing techniques to enhance or manipulate the context-specific mixed audio stream 116. The DSP module 1200 may be used to perform operations such as automatic gain control, audio encoding/decoding, static and other simple noise removal, resampling, and the like.

The depicted audio signal processing subsystem 700 further includes an audio localization module 1202. The audio localization module 1202 may be configured to map received audio waves and/or an audio source to a physical location in an arena environment. By assigning audio sources to a known physical location, the audio signal processing subsystem 700 may be configured to remove audio streams emanating from unwanted locations. Alternatively, the audio signal processing subsystem 700 may be configured to isolate and enhance the context-specific mixed audio stream 116.

The depicted audio signal processing subsystem 700 is further configured to comprise an audio beamforming module 1204 configured to determine or refine beamformed lobes. The audio beamforming module 1204 may employ one or more beamforming techniques such as delay and sum, or may employ a deep neural network (DNN), other specifically trained machine learning (ML) models, or other artificial intelligence-based beamforming techniques.

The audio signal processing subsystem 700 is further configured to comprise an audio source separation module 1206. The audio source separation module 1206 as discussed herein is configured to isolate, route, or filter discrete audio sources from the context-specific mixed audio stream 116. The audio source separation module 1206 may employ its own sophisticated DNN, ML, or artificial techniques to aid in the separation of audio sources. Additionally, the audio source separation module 1206 may be configured to route certain audio sources to dedicated audio channels for specific use cases. Further, the audio source separation module 1206 discussed herein may rely on audio beamforming from the audio beamforming module 1204 discussed above, while in other examples source separation may be performed without the aid of the audio beamforming module 1204.

The audio source separation module 1206 may be a DSP-based source remover. Additionally, the audio source separation module 1206 may utilize a frequency domain filter to determine an audio source based on a ratio of a power of the signal of interest to a power of a signal to be removed. In other words, the audio source separation module 1206 may determine an audio source based on a ratio of a power of the signal of interest to noise to be removed.

The audio signal processing subsystem 700 as depicted in FIG. 7 further includes an acoustic echo cancelation module 1208 configured to reduce or null echo introduced into the context-specific mixed audio stream 116 via the positioning of the sound wave capture devices proximate the arena environment. The audio signal processing subsystem 700 may also include an acoustic source classification module 1210 that is configured to identify and label audio sources or classes. Acoustic source classification module 1210 as discussed herein may rely on classification techniques such as those that determine audio source from fixed microphone locations (e.g., audio streams from a coach mounted lavalier microphone may be reliably tagged as coach-sourced) or on more other techniques such as those that might employ complex ML clustering algorithms to distinguish between on-court sounds and off-court sounds. In some examples, the acoustic source classification module 1210 may be configured to classify the following audio sounds: crowd noise, player speech, floor sounds, ambient sound, PA noise, whistles, a squeak of shoes worn by the athlete, bouncing of a basketball on a basketball court, the “swish” of a basketball passing through a net, and the like.

In some examples, the acoustic source classification module 1210 may utilize machine learning or other artificial intelligence algorithms to identify specific acoustic sources and selectively include or exclude sources from the immersive audio experience. For instance, the acoustic source classification module 1210 may be configured to identify a noise source and noise source components. A noise source refers to the origin or cause of noise, often undesirable, emanating from any region within an arena environment. A noise source may be a speaker (e.g., a public address speaker), arena speakers generating background music and/or advertisements, spectator conversations, wind, squeaking shoes, and/or other similar sounds. A noise source may provide a separate audio feed available to the immersive audio signal processing system through one or more additional audio channels. Identified sources may be selectively removed or enhanced and/or automatically removed or enhanced during operation.

The acoustic source classification module 1210 may be further configured to identify noise audio components. Noise audio components are any undesirable audio data received by a sound wave capture device within the arena environment. For example, noise audio components may include spectator conversations, exclamations from individual spectators, vendor exclamations, announcements from the PA system, background music, and other similar undesirable audio data.

The acoustic source classification module 1210 may utilize a noise source classification to identify an audio signal stream as a noise source and/or the noise audio components within the audio signal stream. A noise source classification refers to a set of features or parameters commonly associated with a noise source. For example, a noise source classification may include frequencies, amplitudes, reverberations, and other similar sound wave features, along with locations, distances, and other features common to one or more particular noise sources. Additionally, a noise source classification may be utilized to identify and isolate the noise source.

One or more beamformed lobes may be updated based on the noise source classification. Updating a beamformed lobe may include any action performed to enhance or suppress at least a portion of the received audio data. Updates to sound wave capture devices may include filtering or amplifying certain frequencies of audio data, and/or filtering or amplifying audio data based on location. Updates to beamformed lobes may be accomplished through DSP configuration and algorithms, enabling or disabling hardware or software filters, adjusting beamforming parameters to steer the location of beamformed lobes, and/or enabling or disabling portions of the digital sound wave capture device (e.g., condenser, transducer) to modify the field of capture of a sound wave capture device.

In some examples, the DSP 1200, the audio localization module 1202, the audio beamforming module 1204, the audio source separation module 1206, the acoustic echo localization module 1208, and/or the acoustic source classification module 1210 may be performed via the pre-processing 118. The depicted audio signal processing subsystem 700 may further include an AI denoising module 1212 that is configured to use DNN, ML, or other AI techniques to determine denoising masks that may be applied to an audio signal sample to remove, cancel, or mute undesired noise, speech, off-court sounds, PA announcements, arena music, and the like.

The audio signal processing subsystem 700 may further include an AI speech removal module 1214 configured to utilize DNN, ML, or artificial intelligence techniques to recognize and remove undesired words and/or sounds from the audio signal streams. In some examples, the AI speech removal module 1214 may rely on AI denoising from the AI denoising module 1212 described herein to remove undesired noise before removing undesired speech. Alternatively, the AI speech removal may be performed without the aid of the AI denoising module 1212.

Additionally, one or more of the DSP module 1200, AI denoising module 1212, AI speech removal module 1214, acoustic echo cancelation module 1208, audio beamforming module 1204, acoustic source classification module 1210, audio source separation module 1206, or audio localization module 1202 may be omitted from the audio signal processing subsystem 700 and instead positioned within some other component of the audio signal processing subsystem 700. For example, one or more of the DSP module 1200, AI denoising module 1212, AI speech removal module 1214, acoustic echo cancelation module 1208, audio beamforming module 1204, acoustic source classification module 1210, audio source separation module 1206, or audio localization module 1202 may be configured for placement in one or more of the one or more capture devices 1201.

The audio signal processing subsystem 700 may be configured to process the context-specific mixed audio stream 116 through one or more of the depicted DSP module 1200, AI denoising module 1212, AI speech removal module 1214, acoustic echo cancelation module 1208, audio beamforming module 1204, acoustic source classification module 1210, audio source separation module 1206, or audio localization module 1202 before outputting the isolated audio 106.

In the depicted example, the isolated audio 106 is transmitted to an output interface 1218. The output interface 1218 may be any electrical exchange boundary facilitating the transfer of the isolated audio 106 and other electronic data from the audio signal processing subsystem 700. In some examples, the output interface 1218 may include wiring, circuitry, cables, and/or another other communication medium. In some examples, the audio signal processing subsystem 700 may interface with a wireless antenna to output the isolated audio 106 as wireless data. In some examples, the output interface 1218 may be utilized to transmit output data to an output device.

The isolated audio 106 may be transmitted to the output interface 1218 in discrete audio channels as informed by the processing of the audio signal streams. Transmitting the isolated audio 106 in discrete channels may allow a remote viewer or a broadcast audio producer (using a production sound mixer) to select targeted audio channels to enhance a particular camera view or video feed.

Additionally, the audio signal processing subsystem 700 may be configured to produce a digital environment encoding. A digital environment encoding refers to a set of configuration parameters, weights, or values that were identified or learned by the audio signal processing subsystem 700 or its constituent components (e.g., DSP module 1200, AI denoising module 1212, AI speech removal module 1214, acoustic echo cancelation module 1208, audio beamforming module 1204, acoustic source classification module 1210, audio source separation module 1206, audio localization module 1202, and/or the neural network model 120) to identify and/or enhance preferred audio data and/or suppress, null, or filter undesirable audio data for a specific arena environment. In some examples, a digital environment encoding may include frequencies, amplitudes, sound wave patterns, and other similar sound wave features utilized by the various modules within the audio signal processing subsystem 700 to classify, identify, locate, isolate, and/or filter audio data specific to an arena environment.

In accordance with various examples, the isolated audio 106 produced by the audio signal processing subsystem 700 is configured to create an immersive audio experience for a remote spectator by virtually positioning the remote spectator within a particular region of an arena environment (e.g., a playing region, a spectator region, playing region adjacent area, etc.) while also optimizing the audio experience (e.g., amplifying or enhancing preferred sounds while filtering or removing undesirable sounds) for the particular region of the arena environment. This remote spectator virtual position may be selected by a television producer or content generator while, in other examples, the remote spectator virtual position may be selected by remote spectators themselves by engaging virtual position option menus presented via a graphical user interface (e.g., an output interface). For example, a remote spectator may choose to begin watching a baseball game virtually by selecting a first immersive audio experience generated from the perspective of the spectator region of a baseball stadium environment but later switch, via option menus rendered via a graphical user interface, to a second immersive audio experience generated from the perspective of the dugout (e.g., a playing region adjacent area).

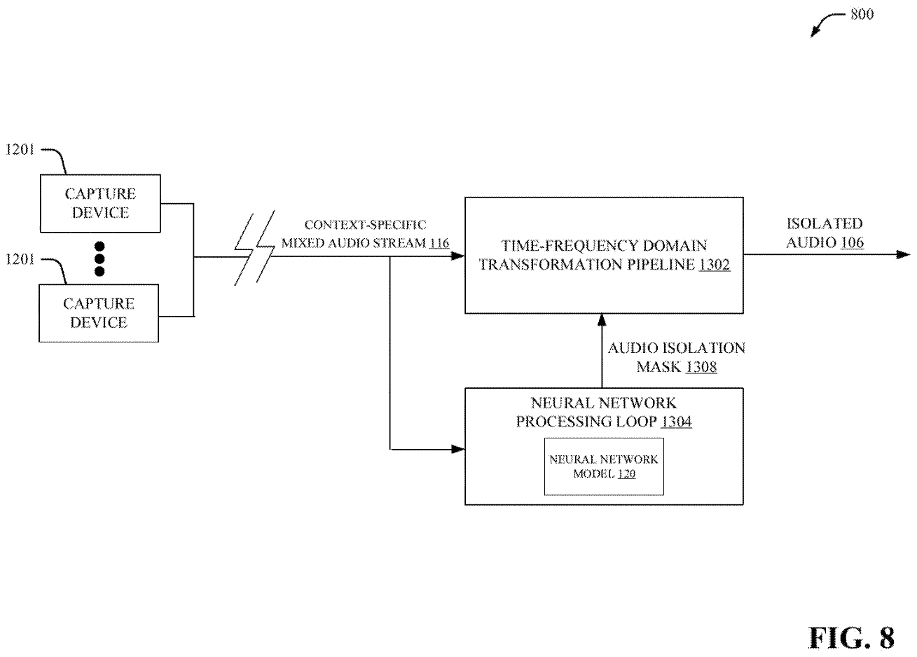

FIG. 8 illustrates audio signal processing subsystem 800 that is configured to provide audio enhancement and/or optimization of an immersive audio experience, according to embodiments of the present disclosure. The audio signal processing subsystem 800 may be a subsystem of the audio signal processing system 100 and/or the audio signal processing subsystem 700. The audio signal processing subsystem 800 includes a time-frequency domain transformation pipeline 1302 and a neural network processing loop 1304. In some examples, the neural network processing loop 1304 corresponds to the neural network model 120 and/or the AI denoising module 1212. Further, the neural network processing loop 1304 may be a DNN processing loop or another type of neural network processing loop.

The context-specific mixed audio stream 116 associated with the context-specific mixed audio stream 116 may be generated by one or more capture devices 1201 may be converted into one or more audio signal samples. The one or more audio signal samples associated with the context-specific mixed audio stream 116 may be provided to the time-frequency domain transformation pipeline 1302 for a transformation period. The time-frequency domain transformation pipeline 1302 may form part of a digital signal processing process. Additionally, the one or more audio signal samples may be provided to the neural network processing loop 1304. The neural network processing loop 1304 may include the neural network model 120 configured to generate at least one audio isolation mask 1308. The transformation period may refer to a time interval during which one or more audio signal samples are processed by the time-frequency domain transformation pipeline 1302. Additionally, the transformation period may define a time interval within which an audio isolation mask may be determined and applied to a frequency domain version of the one or more audio signal samples.

In some examples, the one or more audio signal samples are converted into a non-uniform-bandwidth frequency domain representation. Additionally, the non-uniform-bandwidth frequency domain representation of the one or more audio signal samples may be input to the neural network model 120. The non-uniform-bandwidth frequency domain representation includes a Bark scale format, an Equivalent Rectangular Bandwidth (ERB) format, a wavelet filter banks format, an MFCC format, or another type of format.

In a circumstance where at the at least one audio isolation mask 1308 is determined prior to expiration of the transformation period, the at least one audio isolation mask 1308 may be applied to a frequency domain version of the one or more audio signal samples associated with the time-frequency domain transformation pipeline 1302 to generate the isolated audio 106.

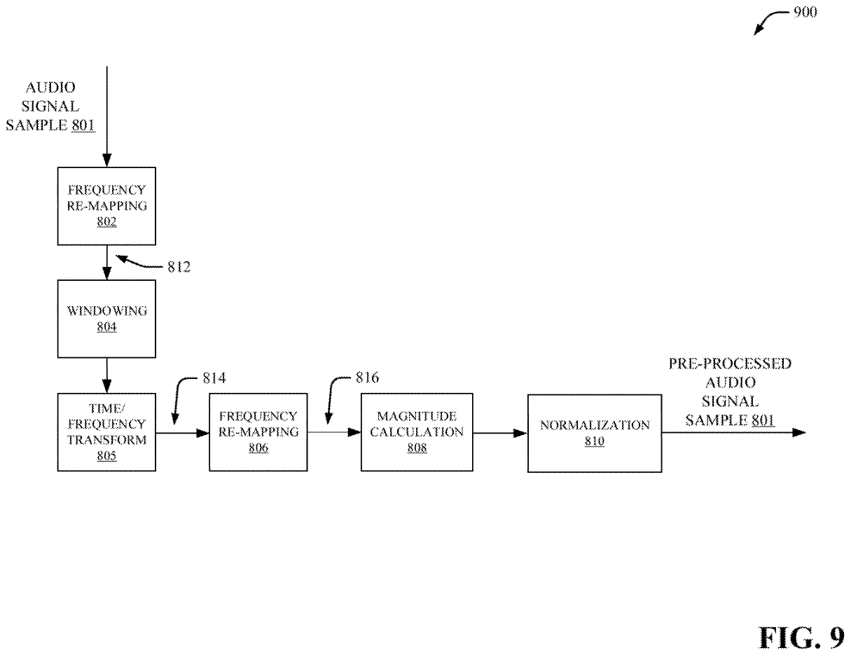

FIG. 9 illustrates a pre-processing subsystem 900 according to embodiments of the present disclosure. The pre-processing subsystem 900 may be a subsystem and/or an example embodiment of the pre-processing 118. The pre-processing subsystem 900 includes frequency re-mapping 802, windowing 804, the time/frequency transform 805, frequency re-mapping 806, a magnitude calculation 808, and/or normalization 810.

To reduce computation time, reduce input dimensionality, and/or format input data according to one or more input data rules for the neural network model 120, an audio signal sample 801 may be provided to the frequency re-mapping 802. The audio signal sample may correspond to at least a portion of the context-specific mixed audio stream 116. The frequency re-mapping 802 may be configured to modify (e.g., scale) frequency of one or more portions of the audio signal sample 801 to generate a modified audio signal sample 812.

The modified audio signal sample 812 may be a modified version of the audio signal sample 801 where a frequency scale for the modified audio signal sample 812 is different than a frequency scale for the audio signal sample 801. For example, the audio signal sample 801 may be associated with a first frequency scale (e.g., a uniformly spaced frequency representation) and the modified audio signal sample 812 may be associated with a second frequency scale (e.g., a non-uniformly spaced frequency representation). A combination of the frequency re-mapping 802, the windowing 804 and the time/frequency transform 805 may correspond to a warped discrete Fourier transform.

The time/frequency transform 805 may be configured to transform the audio signal sample 801 (e.g., a time domain signal sample version of the audio signal sample 801) into a frequency domain audio signal sample version of the audio signal sample 801. In some examples, the time/frequency transform 805 may include a Fourier transform (e.g., a fast Fourier transform, a short-time Fourier transform, etc.) that transforms the audio signal sample 801 into the frequency domain audio signal sample. In some examples, the time/frequency transform 805 may include a discrete cosine transform that transforms the audio signal sample 801 into the frequency domain audio signal sample.

The time/frequency transform 805 may include a cochleargram transform that transforms the audio signal sample 801 into the frequency domain audio signal sample. Alternatively, the time/frequency transform 805 may include a wavelet transform that transforms the audio signal sample 801 into the frequency domain audio signal sample. In some examples, the time/frequency transform 805 may include one or more filter banks that facilitates transforming the audio signal sample 801 into the frequency domain audio signal sample.

The frequency re-mapping 802 may employ one or more digital filters associated with one or more frequency warping operations (e.g., a bilinear transform, an all-pass transformation, etc.) to provide the modified audio signal sample 812. In one or more examples, the windowing 804 may perform one or more windowing operations with respect to the modified audio signal sample 812 to segment the modified audio signal sample 812 into a set of segmented portions for processing by the time/frequency transform 805. The time/frequency transform 805 may be configured to transform the modified audio signal sample 812 (e.g., a time domain signal sample version of the modified audio signal sample 812) into a frequency domain audio signal sample 814 (e.g., a frequency domain audio signal sample version of the modified audio signal sample 812).

The frequency re-mapping 806 facilitates reduced latency by reducing computation time and/or by lowering input dimensionality to the one or more neural network models 111. For example, the frequency re-mapping 806 may be configured for remapping and/or reducing frequency dimensionality for the one or more neural network models 111. Furthermore, the frequency re-mapping 802 facilitates improved quality of the at least one audio isolation mask 119 by allocating lower frequencies to the one or more neural network models 111 and/or by reducing a number of computing resources allocated to higher frequencies (e.g., similar to how a human ear operates). The frequency re-mapping 802 may be configured for improved accuracy of the at least one audio isolation mask 119.

The frequency domain audio signal sample 814 may be provided to the frequency re-mapping 806. The frequency re-mapping 806 may be configured to modify (e.g., scale) frequency of one or more portions of the frequency domain audio signal sample 814 to generate a modified frequency domain audio signal sample 816 (e.g., Bark scale). The modified frequency domain audio signal sample 816 may be a modified version of the frequency domain audio signal sample 814 where a frequency scale for the modified frequency domain audio signal sample 816 is different than a frequency scale for the frequency domain audio signal sample 814. For example, the frequency domain audio signal sample 814 may be associated with the second frequency scale (e.g., Bark scale) and the modified frequency domain audio signal sample 816 may be associated with the frequency scale (e.g., frequency domain).

The frequency re-mapping 806 may employ one or more digital filters and/or one or more transformation filters associated with one or more frequency warping operations (e.g., a bilinear transform, a Bark transformation, etc.) to provide the modified frequency domain audio signal sample 816. In some examples, the magnitude calculation 808 may determine magnitude of one or more portions of the modified frequency domain audio signal sample 816.

The magnitude calculation 808 may facilitate generation of a magnitude spectrogram associated with the modified frequency domain audio signal sample 816. Based on the magnitude of one or more portions of the modified frequency domain audio signal sample 816 (e.g., based on the magnitude spectrogram associated with the modified frequency domain audio signal sample 816), the normalization 810 may normalize an energy mean and/or a variance of the modified frequency domain audio signal sample 816. In some examples, the normalized version of the modified frequency domain audio signal sample 816 may correspond to a pre-processed audio signal sample 801 that is configured for improved feature extraction and/or input into the neural network model 120.

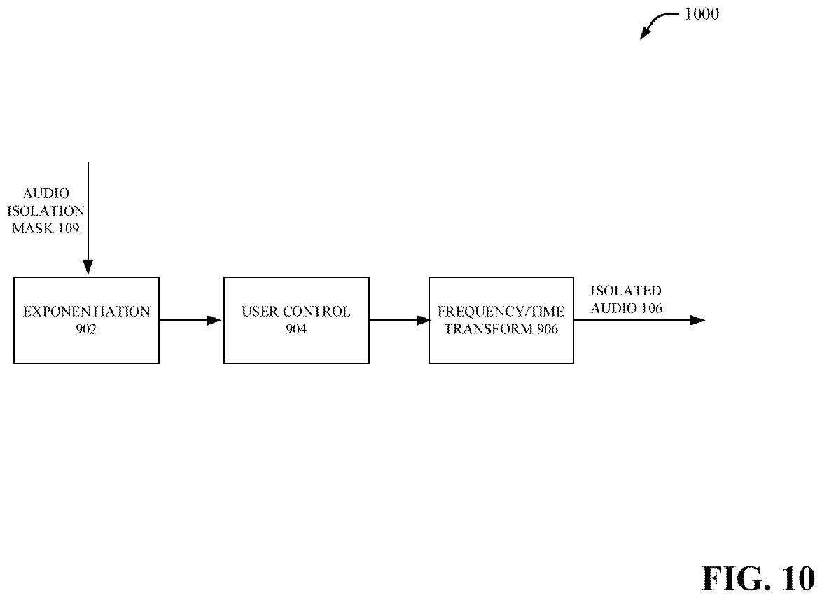

FIG. 10 illustrates a post-processing subsystem 1000 according to embodiments of the present disclosure. The post-processing subsystem 1000 may be a subsystem and/or an example embodiment of the post-processing 122. The post-processing subsystem 1000 includes exponentiation 902, user control 904, and/or a frequency/time transform 906.

The exponentiation 902 may be configured to apply the audio isolation mask 119 to one or more portions of the context-specific mixed audio stream 116. For example, the exponentiation 902 may be configured to perform a multiply function, such as, for example, a Hadamard product, to apply the audio isolation mask 119 to one or more portions of the context-specific mixed audio stream 116. In some examples, the exponentiation 902 may be configured to apply the audio isolation mask 119 to a frequency domain version of the context-specific mixed audio stream 116.

The frequency/time transform 906 may be configured to transform the audio isolated frequency domain version of the context-specific mixed audio stream 116 into the isolated audio 106. In some examples, the frequency/time transform 906 may include an inverse Fourier transform (e.g., an inverse fast Fourier transform, an inverse short-time Fourier transform, an inverse discrete cosine transform, an inverse cochleargram transform, etc.) that transforms the audio isolated frequency domain version of the context-specific mixed audio stream 116 into the isolated audio 106. In some examples, the frequency/time transform 906 may additionally include an inverse Bark conversion process to transforms the audio isolated frequency domain version of the context-specific mixed audio stream 116 into the isolated audio 106. In some examples, the audio isolated frequency domain version of the context-specific mixed audio stream 116 may be modified based on the user control 904 prior to being transformed via the frequency/time transform 906. For example, the user control 904 may utilize the one or more user audio isolation control parameters 130 to modify audio isolated frequency domain version of the context-specific mixed audio stream 116.

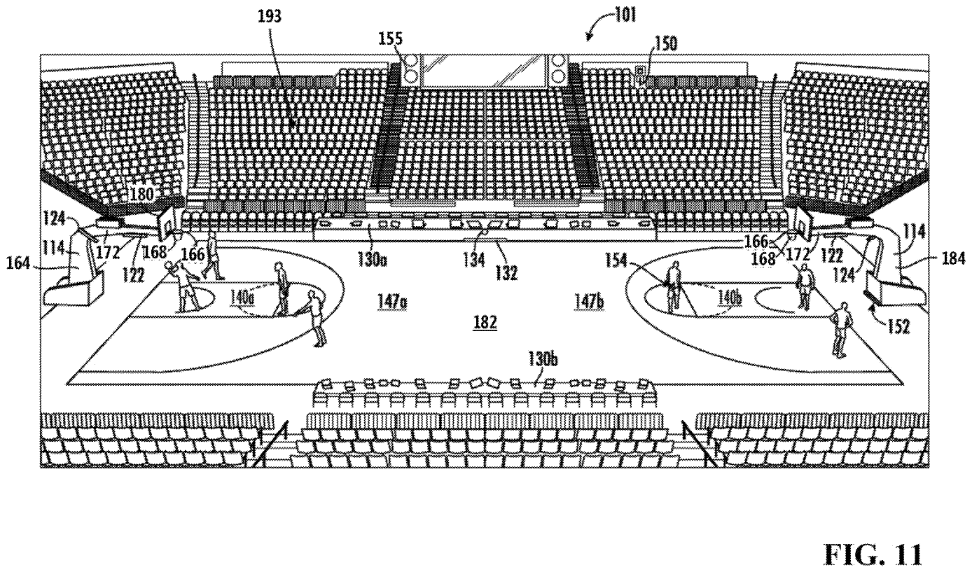

FIG. 11 illustrates an example arena environment 101 that is configured to include the audio signal processing system 100 structured in accordance with various embodiments of the present disclosure. The depicted arena environment 101 is a basketball arena environment. However, s as discussed herein may be configured for operation within a variety of arena environments including football stadium environments, hockey stadium environments, soccer stadium environments, baseball stadium environments, concert hall or stadium environments, theatrical environments, and the like, without departing from the scope of the present disclosure. It will be appreciated that, while embodiments herein are described with respect to an arena environment for illustrative purposes, innovations described herein are applicable to other environments without departing from the scope of the present disclosure.

The example arena environment 101 depicted in FIG. 11 includes a rectangular playing region 182 having two ends and two sides, player bench areas 156a, 156b adjacent to the playing region 182, a spectator region 193, and a noise source region 155. The depicted noise source region 155 includes a jumbotron video board with speakers on lateral sides for playing music and PA remarks to spectators seated in the spectator region 193.

An arena environment may further include a playing region adjacent area (e.g., player bench area 156a, 156b). A playing region adjacent area refers to the physical area of the arena environment in which performers are positioned when they are not in the playing region. For example, the playing region adjacent area may include player bench areas (e.g., player bench area 156a, 156b) in a basketball arena environment, the dugout area in a baseball stadium environment, the backstage area in a concert or theater arena environment, and other similar areas adjacent to a playing region.

At each end of the playing region 182 is a basketball hoop support assembly 184. Each basketball hoop support assembly 184 comprises a rim 166 with an attached net 168 and connected to a backboard 180. Each basketball hoop support assembly 184 further comprises a horizontal hoop support beam 172 and a vertical hoop support beam 114 physically coupled by a support beam connector and configured to hold the backboard 180, rim 166, and net 168 in an elevated position. Each basketball hoop support assembly 184 is configured to support a number of capture devices.

In FIG. 11, a support base linear array sound wave capture device 152 is depicted positioned near the base of the basketball hoop support assembly 184. In the depicted example, the support base linear array sound wave capture device 152 is directed generally toward the surface of the playing region 182. Positioning a support base linear array sound wave capture device 152 near the base of the basketball hoop support assembly 184 and directed toward the playing region 182 allows overlapping coverage of the areas of the court of highest interest, such as the key areas (140a, 140b) and surrounding areas.

As disclosed herein, an array sound wave capture device such as the linear array sound wave capture device 152 refers to a sound wave capture device comprising a plurality of transducers configured to utilize signal processing techniques to uniformly capture and process sound wave data. An array sound wave capture device may use beamforming techniques to produce one or more steerable beamformed lobes. Example array sound wave capture devices include linear array sound wave capture devices, planar array sound wave capture devices, circular array sound wave capture devices, 2D array sound wave capture devices, 3D surface array sound wave capture devices, suspended 3D array sound wave capture devices, and the like. Array sound wave capture devices may further include 1.5D array sound wave capture devices. A 1.5D array sound wave capture device is an array sound wave capture device configured to provide a one-dimensional form factor that, in some examples, has added directivity, for most, if not all, frequencies, in dimensions that, conventionally, have equal sensitivity in all directions.

An array sound wave capture device may include a plurality of transducers arranged such that the length of the array of transducers exceeds the width. Further, a linear array arrangement of transducers may allow a linear array sound wave capture device to be configured to use highly selective end fire beamformed lobes to capture sound emanating from a direction parallel to the linear array and broadside beamformed lobes to capture sound emanating from a direction perpendicular to the linear array. As referenced herein, example linear array sound wave capture devices include ground linear array sound wave capture devices, hanging linear array sound wave capture devices, angled linear array sound wave capture devices, support base linear array sound wave capture devices, spectator linear array sound wave capture devices, and the like.

The depicted support base linear array sound wave capture device 152 may be, for example, a four-foot array sound wave capture device that is configured to produce up to 8 beamformed steerable lobes. Although depicted as a linear array sound wave capture device, the support base linear array sound wave capture device 152 may be any multi-lobe digital sound wave capture device capable of capturing playing region audio content.

As referenced herein, a multi-lobe digital sound wave capture device refers to any sound wave capture device configured to filter and/or enhance received sound waves to achieve spatial selectivity in the form of discrete beamformed lobes. A multi-lobe digital sound wave capture device may comprise a steerable digital sound wave capture device. Additionally, a multi-lobe digital sound wave capture device may comprise a switchable sound wave capture device.

A steerable digital sound wave capture device refers to any multi-lobe digital sound wave capture device that is configured to move or reposition one or more beamformed lobes from a first audio capture area to a second audio capture area. Such adjustment may be performed via beamforming techniques, such as delay and sum. In some examples, the width, distance, and number of beamformed lobes generated by a steerable digital sound wave capture device may be adjusted through beamforming techniques. Example steerable digital sound wave capture devices include various array sound wave capture devices. A steerable digital sound wave capture device may be configured to transmit and receive wireless communication such that one or more beamformed lobes may be updated remotely.

As referenced herein, an audio capture area refers to the physical area from which a particular capture device may receive audio data. For example, in a directed capture device, such as a shotgun microphone, the audio capture may include a narrow but long audio capture area, such that audio data may be captured from physical locations in a very narrow or directed set of locations. In another example, a circular array sound wave capture device may simultaneously capture audio data in a wide set of physical locations. Some devices, such as multi-lobe digital sound wave capture devices may be continually updated to change the audio capture area of the device. A multi-lobe sound wave capture device may be configured to capture audio data from a narrow audio capture area, while in other instances, a multi-lobe sound wave capture device may be configured to capture audio data from a wide audio capture area. Further, a narrow audio capture area may receive audio data from further physical locations due to reductions in noise from other audio sources.

To capture additional audio content on or near the playing region 182, some or all of the participants (e.g., players, coaches, referees, etc.) may be equipped with a bodypack sound wave capture device 154. The depicted bodypack sound wave capture device 154 is a player microphone, however, the bodypack sound wave capture device 154 may be any sound wave capture device that may be worn by a player or other participant while still providing for participation. Utilization of a bodypack sound wave capture device 154 allows capture and transmission of player, coach, and referee conversations, as well as other on-court and in-game audio content that adds to an immersive audio experience. Such bodypack sound wave capture devices 154 also allow for the capture of playing region adjacent area audio data, such as player bench area 156a, 156b audio coverage.

The depicted arena environment 101 further includes a first scorer's table 130a and a second scorer's table 130b positioned on the surface of the playing region 182 and running parallel to each lateral side of the playing region 182. In the depicted example, a table top array sound wave capture device 134 has been hung from the first scorer's table 130a and directed toward the playing region 182. A ground linear array sound wave capture device 132 is disposed on the floor surface of the playing region 182 at the base of the first scorer's table 130a and directed upward from the surface of the playing region 182.

During a basketball game, the depicted playing region 182 is populated with participating players, referees, team coaches, cheerleaders, halftime show members, and others. These participants will create a variety of sounds, many of which are not effectively captured by directional microphone setups but which, if captured, would add considerable value to an immersive audio experience for a remote viewing spectator. For example, conversations between players, coaches, and referees; player exclamations; floor noises such as squeaking shoes and bouncing balls; whistles; and so on, collectively referred to as on-court sounds are inconsistently or infrequently captured but should play a central role in any immersive experience. Playing region adjacent area noises, such as conversations in the player bench area 156a, 156b, may be selectively included or excluded in an immersive audio experience.

The depicted arena environment 101 includes a spectator region 193. The spectator region refers to the portion of the arena environment designated for in-person spectators during game play or a performance. The spectator region includes seating and viewing areas for in-person spectators to watch the events occurring in the playing region. In some examples, the spectator region may be configured in an amphitheater configuration such that it fully or partially encircles the playing region. The spectator region may also be configured to encompass one or two lateral sides of the playing region. The depicted spectator region 193 of FIG. 11 provides seating and viewing areas for in-person spectators to watch the basketball game occurring in the playing region 182.

The depicted spectator region 193 may be the source of a number of sounds during a basketball game. Some of these sounds may be desirable for inclusion in a television broadcast while others are undesirable and should be excluded. For example, crowd cheers and boos may be considered as desirable sounds to be included in a television broadcast while other sounds, such as spectator conversations, exclamations from individual spectators, and announcements from the PA system, may be deemed undesirable.

In addition, FIG. 11 depicts a spectator linear array sound wave capture device 150. In the depicted example, the spectator linear array sound wave capture device 150 is mounted to the base of a camera positioned in the spectator region 193. Mounting a spectator linear array sound wave capture device 150 on or near a camera may allow an ambient perspective immersive audio experience to be created, such that the captured audio content corresponds with the movement and/or panning of the camera.

Although the depicted spectator linear array sound wave capture device 150 is mounted to the base of a camera positioned in the spectator region 193, a spectator linear array sound wave capture device 150 may be positioned on or near the body of the camera, or anywhere in or near the spectator region 193. The depicted spectator linear array sound wave capture device 150 is a four-foot array sound wave capture device, however, the spectator linear array sound wave capture device 150 may be any multi-lobe digital sound wave capture device configured to capture and transmit surrounding audio content. Utilizing a spectator linear array sound wave capture device 150 allows the capture of in-audience sounds adding to the immersive audio experience. Although only one spectator linear array sound wave capture device 150 is shown, multiple such devices may be used throughout the spectator region 193 as may be appropriate for adequate audio coverage.

Some wave capture devices may be strategically placed to capture and process audio signal streams originating from the spectator region 193. Depending on the desired user experience, this audio content may be mixed with other streams for transmission to a remote viewing display. Alternatively, the audio signal streams from the spectator region 193 may be isolated according to classified audio source (e.g., shouting vendors, etc.) and/or locality and may be selectively removed from audio streams that form a desired immersive audio experience.

For example, the audio signal processing system 100 may be configured to provide a playing region 182 audio stream mixed with an audio stream of cheers and boos drawn from a crowd seated in the spectator region 193 to add to the immersive audio experience. While in another immersive audio experience, the audio signal processing system 100 may be configured to provide a playing region 182 audio stream with audio signal streams originating from the spectator region 193 entirely removed, if, for example, there is a desire to emphasize player conversations, coaches and referee discussions, floor sounds, or other indistinct on-court sounds.

As further depicted in FIG. 11, the arena environment 101 includes a noise source region 155. A noise source region refers to the portion of the arena environment from which additional sound waves may emanate. In some examples, the noise source region may include sound waves from the PA announcer, audio advertisements and announcements, music, and other sounds emanating from the arena environment speakers.

The arena environment 101 may also include sound wave capture devices (not shown) that are directed toward the noise source region 155. By capturing noise source region 155 originating audio signal streams, such immersive audio signal processing systems are configured to isolate or cancel audio from the noise source region 155. Alternatively, audio streams originating from the noise source region 155 may be captured without dedicated sound wave capture devices by tapping an audio feed to the depicted jumbotron or speaker array to provide an auxiliary audio feed.

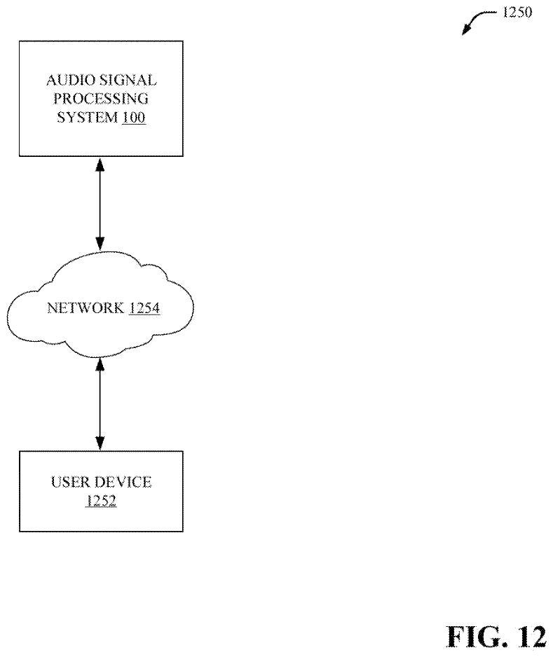

FIG. 12 illustrates an example system 1250 according to one or more embodiments of the present disclosure. The system 1250 includes a user device 1252 configured to interact with the audio signal processing system 100 via a network 1254. For example, in one or more embodiments, the user device 1252 may be configured to send data to the audio signal processing system 100 and/or receive data from the audio signal processing system 100. The user device 1252 may be configured to send the one or more user audio isolation control parameters 130 to the audio signal processing system 100 via the network 1254. Additionally, the user device 1252 may be configured to receive dynamic isolated audio interface data (e.g., data associated with a dynamic audio isolation interface, etc.) from the audio signal processing system 100.

The user device 1252 may also be configured to render a dynamic isolated audio interface to visually indicate a degree of isolated arena audio provided by the at least one audio isolation mask 119. For example, in some examples, the user device 1252 may be configured to render an isolated audio meter interface to visually indicate a degree of noise reduction, dereverberation, and/or other audio filtering provided by the at least one audio isolation mask 119. The user device 1252 may be a smartphone, a tablet computer, a laptop, a personal computer, an audio workstation device, a wearable device, an augmented reality device, a virtual reality device, or another type of user device that includes one or more displays.

The network 1254 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 1254 (e.g., network routers, etc.). For example, the network 1254 may include a cellular telephone, an 802.11, 802.16, 802.18, and/or WiMAX network. Further, the network 1254 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some examples, the protocol is a custom protocol of JSON objects sent via a WebSocket channel. In some examples, the protocol is JSON over RPC, JSON over REST/HTTP, the like, or combinations thereof. In some examples, the network 1254 is configured for exchanging data over short distances (e.g., less than 33 feet) using ultra high frequency (UHF) radio waves.

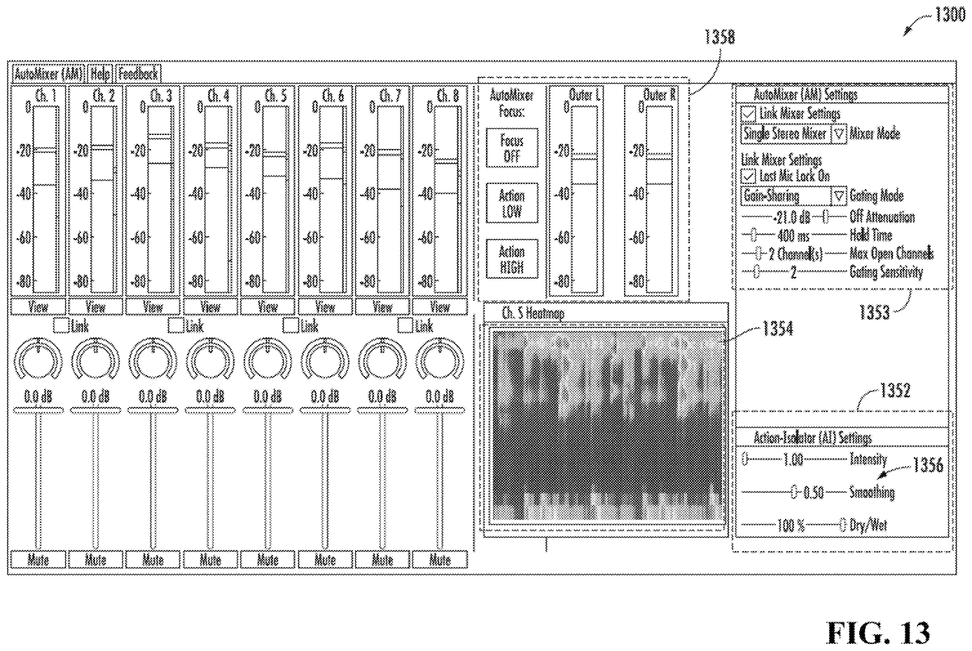

FIG. 13 illustrates an audio processing control user interface 1300 according to one or more embodiments of the present disclosure. The audio processing control user interface 1300 may be, for example, an electronic interface (e.g., a graphical user interface) of a client device (e.g., the user device 1252). The audio processing control user interface 1300 may be a client device interface, a web user interface, a mobile application interface, or the like. In some examples, the audio processing control user interface 1300 includes a dynamic channel control interface 1352. The audio processing control user interface 1300 may also include an automixer settings interface 1353 that enables user control of gating modes, attenuation, hold time, open channels, and/or gaiting sensitivity associated with the automixer 112. The audio processing control user interface 1300 includes a heatmap visualization 1354 to dynamically render visual data associated with the isolated audio 106 via a heatmap.

The dynamic channel control interface 1352 includes one or more user engagement interfaces 1356. One or more user engagement interfaces 1356 may respectively be a slide control interface configured to control and/or modify a value of the one or more user audio isolation control parameters 130 for the context-specific mixed audio stream 116. The one or more user engagement interfaces 1356 may enable user control of intensity audio characteristics, release audio characteristics, reverberation audio characteristics, and/or one or more other audio characteristics for the isolated audio 106. In response to a user engagement with respect to the one or more user engagement interfaces 1356, one or more control signals associated with the one or more user audio isolation control parameters 130 may be transmitted to the audio signal processing system 100 via the network 1254.

The audio processing control user interface 1300 may include an automixer focus control element 1358. The automixer focus control element 1358 may be configured to guide the audio channel processing performed by the automixer 112 without directly applying AI processing to the output audio. Additionally, the automixer focus control element 1358 may enable a user to adjust the intensity of focus for specific audio elements such as game sounds in a sports context. For instance, setting the automixer focus control element 1358 to a high action setting while keeping AI output disabled may result in mixed microphone signals with a pronounced emphasis on game sounds without actively removing non-game audio elements.

The automixer focus control element 1358 may be implemented in conjunction with a control element to enable AI output. For instance, when the control element to enable AI output is activated, non-sport sounds may be actively removed in a sports audio context to refining the audio output. Additionally, the automixer focus control element 1358 may effectively modulate the control signal output represented by the one or more contextual audio classifications 109 to guide mixing decisions for the automixer 112. This control may influence the intensity of isolation applied to the audio masks generated by the neural network model 110.

The audio masks may be utilized to generate the one or more contextual audio classifications 109 and/or to produce the isolated audio 106 via the post-processing 122. The intensity of isolation applied to the audio masks for generating the one or more contextual audio classifications 109 may be directly controlled by the automixer focus control element 1358, while the same masks used in the post-processing 122 may be further modified based on the action isolator settings in the dynamic channel control interface 1352. As such, fine-tuned control over both the automixing process and the final audio output may be provided to enable audio output with a desired balance between focused audio elements and overall sound quality.

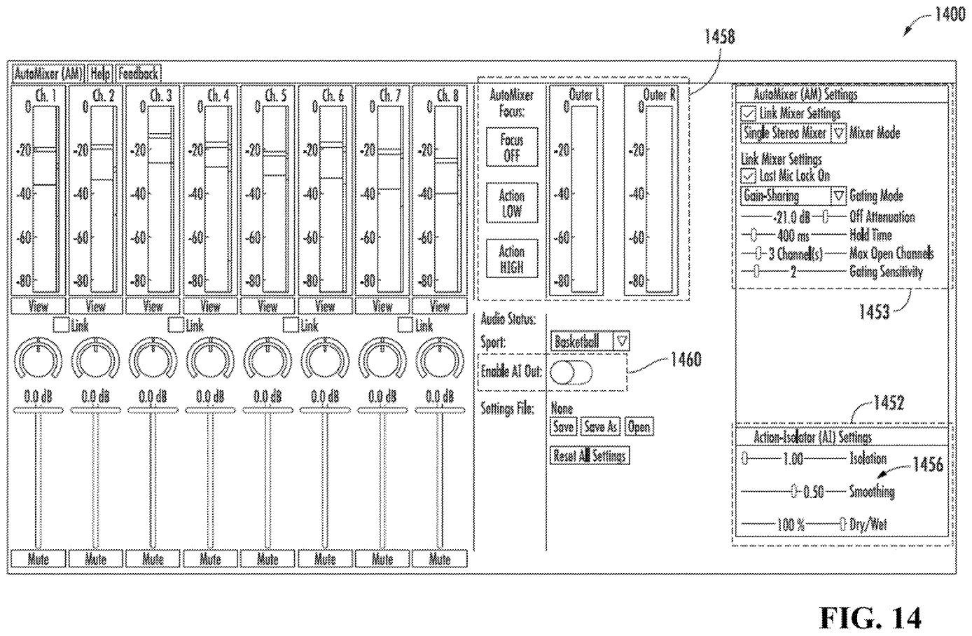

FIG. 14 illustrates an audio processing control user interface 1400 according to one or more embodiments of the present disclosure. The audio processing control user interface 1400 may be, for example, an electronic interface (e.g., a graphical user interface) of a client device (e.g., the user device 1252). The audio processing control user interface 1400 may be a client device interface, a web user interface, a mobile application interface, or the like. In some examples, the audio processing control user interface 1400 includes a dynamic channel control interface 1452. The audio processing control user interface 1400 may also include an automixer settings interface 1453 that enables user control of gating modes, attenuation, hold time, open channels, and/or gaiting sensitivity associated with the automixer 112.

The dynamic channel control interface 1452 includes one or more user engagement interfaces 1456. The one or more user engagement interfaces 1456 may respectively be a slide control interface configured to control and/or modify a value of the one or more user audio isolation control parameters 130 for the context-specific mixed audio stream 116. Additionally, the one or more user engagement interfaces 1456 may enable user control of intensity audio characteristics, release audio characteristics, reverberation audio characteristics, and/or one or more other audio characteristics for the isolated audio 106. In response to a user engagement with respect to the one or more user engagement interfaces 1456, one or more control signals associated with the one or more user audio isolation control parameters 130 may be transmitted to the audio signal processing system 100 via the network 1254.

The audio processing control user interface 1400 may include an automixer focus control element 1458. The automixer focus control element 1458 may be configured to guide the audio channel processing performed by the automixer 112 without directly applying AI processing to the output audio. Additionally, the automixer focus control element 1458 may enable a user to adjust the intensity of focus for specific audio elements such as game sounds in a sports context. For instance, setting the automixer focus control element 1458 to a high action setting while keeping AI output disabled may result in mixed microphone signals with a pronounced emphasis on game sounds without actively removing non-game audio elements.

The automixer focus control element 1458 may be implemented in conjunction with a control element 1460 to enable AI output. For instance, when the control element 1460 to enable AI output is activated, non-sport sounds may be actively removed in a sports audio context to refining the audio output. Additionally, the automixer focus control element 1458 may effectively modulate the control signal output represented by the one or more contextual audio classifications 109 to guide mixing decisions for the automixer 112. This control may influence the intensity of isolation applied to the audio masks generated by the neural network model 110.

The audio masks may be utilized to generate the one or more contextual audio classifications 109 and/or to produce the isolated audio 106 via the post-processing 122. The intensity of isolation applied to the audio masks for generating the one or more contextual audio classifications 109 may be directly controlled by the automixer focus control element 1458, while the same masks used in the post-processing 122 may be further modified based on the action isolator settings in the dynamic channel control interface 1452. As such, fine-tuned control over both the automixing process and the final audio output may be provided to enable audio output with a desired balance between focused audio elements and overall sound quality.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The term “artificial intelligence model,” “AI model,” “machine learning model,” and “ML model” refer to computational systems that implement machine learning or deep learning algorithms. The term “artificial intelligence” or “AI” refers broadly to computer systems designed to perform tasks that typically require human intelligence, including but not limited to reasoning, learning, problem-solving, perception, and natural language understanding. The term “machine learning” refers to a subset of artificial intelligence encompassing methods and algorithms that enable computer systems to learn patterns from data and make predictions or decisions without being explicitly programmed with rules for each specific scenario. Machine learning models are computer-implemented algorithms that may learn from data stored in databases or datastores, with or without relying on rules-based programming. These models enable reliable, repeatable decisions and results and facilitate the uncovering of hidden insights through machine-based learning from historical relationships and trends in the data.

Machine learning encompasses two primary learning paradigms: supervised learning and unsupervised learning. In supervised learning, a model is trained on a labeled dataset where each input example is paired with a corresponding target output or label. The model learns to map inputs to outputs by minimizing the difference between its predictions and the known labels. Examples of supervised learning tasks include classification (e.g., categorizing data into discrete classes such as spam detection, image recognition, or sentiment classification) and regression (e.g., predicting continuous values such as prices, temperatures, or durations).

Common supervised learning algorithms include linear regression, logistic regression, support vector machines (SVMs), decision trees, random forests, gradient boosting machines (e.g., XGBoost, LightGBM, CatBoost), k-nearest neighbors (KNN), and neural networks. In unsupervised learning, a model is trained on unlabeled data and must discover patterns, structures, or relationships within the data without explicit guidance. Examples of unsupervised learning tasks include clustering (e.g., grouping similar data points together using algorithms such as k-means, hierarchical clustering, DBSCAN, or Gaussian mixture models), dimensionality reduction (e.g., reducing the number of features while preserving important information using techniques such as principal component analysis (PCA), t-SNE, or UMAP), and anomaly detection (e.g., identifying unusual patterns or outliers in data). Semi-supervised learning combines elements of both paradigms, using a small amount of labeled data alongside a larger amount of unlabeled data to improve model performance.

An AI model is initially fit or trained on a training dataset comprising a set of examples used to fit or adjust the parameters of the model. During training, the AI model processes input data, generates predictions or outputs, and compares these outputs against target values (in supervised learning) or optimization objectives (in unsupervised learning). Based on the result of this comparison and the specific learning algorithm being used, the parameters of the model are adjusted through optimization techniques such as gradient descent, stochastic gradient descent (SGD), Adam, RMSprop, or other optimization algorithms.

Training data may be stored in databases or datastores and accessed via one or more application programming interfaces. The training process typically involves iterating over the training data multiple times (epochs) until the model converges to a satisfactory level of performance. Model performance is evaluated using metrics appropriate to the task, such as accuracy, precision, recall, F1 score, area under the ROC curve (AUC-ROC), mean squared error (MSE), mean absolute error (MAE), or other evaluation metrics. The machine learning models as described herein may make use of multiple ML engines (e.g., for analysis, transformation, inference, and other needs). The system may train different ML models for different needs and different ML-based engines, generate new models based on gathered training data, and evaluate their performance against existing models.

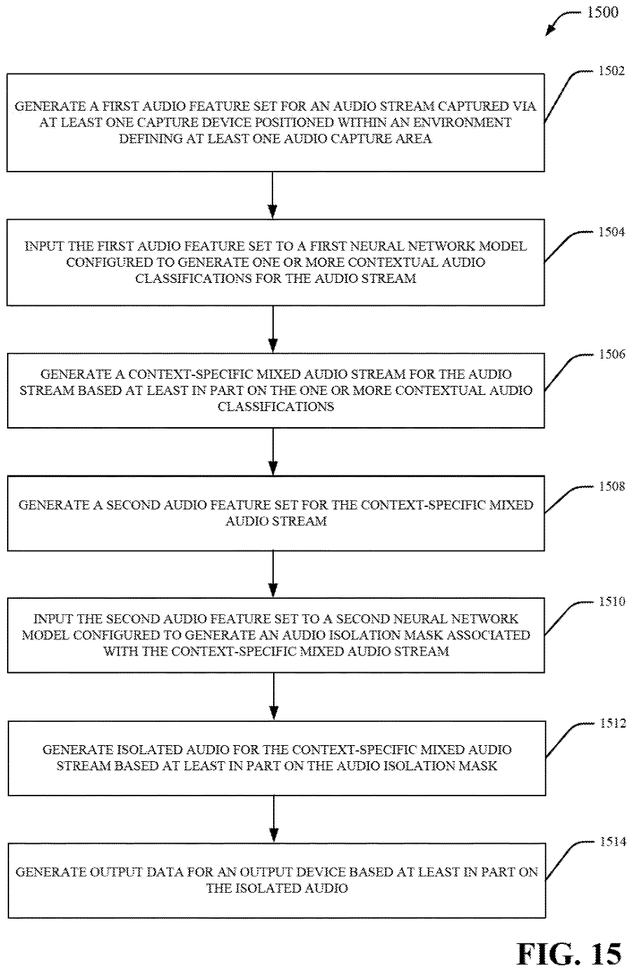

FIG. 15 is a flowchart diagram of an example process 1500, for providing audio enhancement and optimization using contextual audio signal processing, in accordance with, for example, the audio signal processing system 100 and/or the audio signal processing apparatus 151. Via the various operations of the process 1500, the audio signal processing system 100 and/or the audio signal processing apparatus 151 may enhance audio isolation, quality, and/or reliability of an audio stream associated with an audio environment.

At block 1502, a processor (e.g., the processor 154 and/or the ML processing circuitry 158) generates a first audio feature set for an audio stream captured via at least one capture device positioned within an environment defining at least one audio capture area.

The first audio feature set may be a model input audio feature set for a neural network model for providing one or more contextual audio classifications associated with the audio stream. For instance, the first audio feature set may be a collection of audio characteristics extracted from the audio stream. Additionally, the first audio feature set may comprise features to enable contextual audio classification of the audio stream. In some examples, the first audio feature set comprises: one or more: audio spectrum features, magnitude features, phase features, pitch features, harmonic features, Mel spectrogram features, wavelet transform features, MFCC features, performance features, performance sequencer features, tempo features, time signature features, spectral centroid features, spectral flux features, zero-crossing rate features, energy envelope features, features related to an ERB scale, STFT features, filter bank features, and/or other types of features associated with the audio stream.

At block 1504, a processor (e.g., the processor 154 and/or the ML processing circuitry 158) inputs the first audio feature set to a first neural network model configured to generate one or more contextual audio classifications for the audio stream.

The first neural network model may be configured to contextualize the audio stream based on the first audio feature set. For example, the first neural network model may enable an understanding of context and/or content of the audio stream. The first neural network model may be trained to recognize and classify various audio contexts. The first neural network model may be configured as a deep learning architecture, such as a CNN, RNN, or a hybrid model combining multiple architectures. In some examples, the first neural network model may include multiple layers of artificial neurons, each performing specific transformations on the first audio feature set.

At block 1506, a processor (e.g., the processor 154 and/or the DSP processing circuitry 160) generates a context-specific mixed audio stream for the audio stream based at least in part on the one or more contextual audio classifications.

The context-specific mixed audio stream may represent an optimized version of the audio stream that is tailored to the specific context identified by the one or more contextual audio classifications. The context-specific mixed audio stream may include one or more audio channels based on a desired output configuration (e.g., mono, stereo, multi-channel surround sound, etc.). The context-specific mixed audio stream may also include metadata that describes the applied processing via an automixer and/or contextual information associated with the one or more contextual audio classifications.

At block 1508, a processor (e.g., the processor 154 and/or the ML processing circuitry 158) generates a second audio feature set for the context-specific mixed audio stream.

The second audio feature set may be a model input audio feature set for the second neural network model utilized for providing audio isolation, denoising, speech removal, and/or other filtering of sound with respect to the context-specific mixed audio stream. In some examples, the second audio feature set includes one or more audio features for the context-specific mixed audio stream. The second audio feature set may comprise: one or more: audio spectrum features, magnitude features, phase features, pitch features, harmonic features, MFCC features, performance features, performance sequencer features, tempo features, time signature features, and/or other types of features associated with the context-specific mixed audio stream.

At block 1510, a processor (e.g., the processor 154 and/or the ML processing circuitry 158) inputs the second audio feature set to a second neural network model configured to generate an audio isolation mask associated with the context-specific mixed audio stream.

The second neural network model may be configured to process the second audio feature set and generate the audio isolation mask. In some examples, the second neural network model may be utilized to separate and/or isolate specific audio components from the context-specific mixed audio stream. The second neural network model may be implemented as a deep learning architecture specialized for audio source separation and/or mask estimation processing. For example, the second neural network model may include a U-Net structure, a deep clustering network, or a transformer-based model.

At block 1512, a processor (e.g., the processor 154 and/or the ML processing circuitry 158) generates isolated audio for the context-specific mixed audio stream based at least in part on the audio isolation mask.

The isolated audio may refer to a transformed version of the audio stream that has been processed via contextual-based audio mixing and machine learning to separate and/or isolate specific audio components from a context-specific mixed audio stream version of the audio stream. In some examples, the isolated audio may be an isolated audio signal, isolated audio channel data, or an isolated audio stream that has been processed via contextual-based audio mixing and machine learning to emphasize or extract specific desired audio components while suppressing or removing undesirable audio components.

At block 1514, a processor (e.g., the processor 154, the input/output circuitry 162, and/or by the communications circuitry 164) generates output data for an output device based at least in part on the isolated audio.

The output device may be an audio mixer device, a DSP processing device, a smartphone, a tablet computer, a laptop, a personal computer, an audio workstation device, a wearable device, an augmented reality device, a virtual reality device, a broadcasting device, a recording device, a microphone, headphones, earphones, speakers, a haptic device, or another type of output device. Additionally, the output data may include: an audio stream, a video stream, broadcast audio, broadcast video, speech reinforcement audio, a control signal, visual data for rendering via an electronic interface, training data for one or more machine learning models, and/or other output data.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the at least one processor, to cause the apparatus to: generate a first audio feature set for an audio stream captured via at least one capture device positioned within an environment defining at least one audio capture area.

Clause 2. The apparatus of clause 1, wherein the instructions are further operable to cause the apparatus to: input the first audio feature set to a first neural network model configured to generate one or more contextual audio classifications for the audio stream.

Clause 3. The apparatus of any one of the foregoing clauses, wherein a contextual audio classification of the one or more contextual audio classifications predicts a class of audio for the audio stream.

Clause 4. The apparatus of any one of the foregoing clauses, wherein the instructions are further operable to cause the apparatus to: generate a context-specific mixed audio stream for the audio stream based at least in part on the one or more contextual audio classifications.

Clause 5. The apparatus of any one of the foregoing clauses, wherein the instructions are further operable to cause the apparatus to: generate a second audio feature set for the context-specific mixed audio stream.

Clause 6. The apparatus of any one of the foregoing clauses, wherein the instructions are further operable to cause the apparatus to: input the second audio feature set to a second neural network model configured to generate an audio isolation mask associated with the context-specific mixed audio stream.

Clause 7. The apparatus of any one of the foregoing clauses, wherein the instructions are further operable to cause the apparatus to: generate isolated audio for the context-specific mixed audio stream based at least in part on the audio isolation mask.

Clause 8. The apparatus of any one of the foregoing clauses, wherein the instructions are further operable to cause the apparatus to: generate output data for an output device based at least in part on the isolated audio.

Clause 9. The apparatus of any one of the foregoing clauses, wherein the instructions are further operable to cause the apparatus to: generate an audio contextualization mask associated with the audio stream based at least in part on the first audio feature set.

Clause 10. The apparatus of any one of the foregoing clauses, wherein the instructions are further operable to cause the apparatus to: generate the one or more contextual audio classifications for the audio stream based at least in part on the audio contextualization mask.

Clause 11. The apparatus of any one of the foregoing clauses, wherein the instructions are further operable to cause the apparatus to: generate the context-specific mixed audio stream by adapting gain associated with the audio stream based at least in part on the one or more contextual audio classifications.

Clause 12. The apparatus of any one of the foregoing clauses, wherein the instructions are further operable to cause the apparatus to: generate the context-specific mixed audio stream by controlling a noise adaptive threshold for an automatic microphone mixer based at least in part on the one or more contextual audio classifications.

Clause 13. The apparatus of any one of the foregoing clauses, wherein the instructions are further operable to cause the apparatus to: generate the context-specific mixed audio stream by controlling a gating decision for an automatic microphone mixer based at least in part on the one or more contextual audio classifications.

Clause 14. The apparatus of any one of the foregoing clauses, wherein the instructions are further operable to cause the apparatus to: generate the context-specific mixed audio stream by controlling a degree of panning associated with the audio stream based at least in part on the one or more contextual audio classifications.

Clause 15. The apparatus of any one of the foregoing clauses, wherein the instructions are further operable to cause the apparatus to: determine a probability score for the one or more contextual audio classifications.

Clause 16. The apparatus of any one of the foregoing clauses, wherein the instructions are further operable to cause the apparatus to: responsive to the probability score satisfying a defined probability threshold, adapt gain associated with the audio stream based at least in part on the one or more contextual audio classifications.

Clause 17. The apparatus of any one of the foregoing clauses, wherein the instructions are further operable to cause the apparatus to: generate isolated audio for the context-specific mixed audio stream based at least in part on (i) the audio isolation mask and (ii) one or more user audio isolation control parameters.

Clause 18. The apparatus of any one of the foregoing clauses, wherein the instructions are further operable to cause the apparatus to: input an audio signal sample associated with the context-specific mixed audio stream to a time-frequency domain transformation pipeline of a digital signal processing process for a transformation period.

Clause 19. The apparatus of any one of the foregoing clauses, wherein the instructions are further operable to cause the apparatus to: input the audio signal sample to a deep neural network (DNN) processing loop comprising the second neural network model to generate the audio isolation mask.

Clause 20. The apparatus of any one of the foregoing clauses, wherein the instructions are further operable to cause the apparatus to: based on the audio isolation mask being determined prior to expiration of the transformation period, apply the audio isolation mask to a frequency domain version of the audio signal sample associated with the time-frequency domain transformation pipeline to generate the isolated audio.

Clause 21. The apparatus of any one of the foregoing clauses, wherein the instructions are further operable to cause the apparatus to: perform beam steering associated with the at least one capture device based at least in part on the audio isolation mask.

Clause 22. The apparatus of any one of the foregoing clauses, wherein the instructions are further operable to cause the apparatus to: modify a shape of a beamforming lobe associated with the at least one capture device based at least in part on the audio isolation mask.

Clause 23. The apparatus of any one of the foregoing clauses, wherein the instructions are further operable to cause the apparatus to: initiate selection of an audio channel associated with desirable audio based at least in part on the audio isolation mask.

Clause 24. The apparatus of any one of the foregoing clauses, wherein the audio isolation mask comprises a denoiser mask, a speech removal mask, or a signal of interest mask.

Clause 25. The apparatus of any one of the foregoing clauses, wherein the output data comprises mono audio, stereo audio, or three-dimensional audio.

Clause 26. The apparatus of any one of the foregoing clauses, wherein the output data comprises a sub-mix audio channel associated with spatial audio.

Clause 27. The apparatus of any one of the foregoing clauses, wherein the output data comprises broadcast audio.

Clause 28. The apparatus of any one of the foregoing clauses, wherein the output data comprises speech reinforcement audio.

Clause 29. The apparatus of any one of the foregoing clauses, wherein the output data comprises visual data configured to render via a display of the output device.

Clause 30. The apparatus of any one of the foregoing clauses, wherein the output device is a haptic device, and wherein the output data comprises a control signal for the haptic device.

Clause 31. The apparatus of any one of the foregoing clauses, wherein the output data comprises a video stream associated with the isolated audio.

Clause 32. A computer-implemented method comprising steps in accordance with any one of the foregoing clauses

Clause 33. A computer program product, stored on a computer readable medium, comprising instructions that, when executed by one or more processors of the audio signal processing apparatus, cause the one or more processors to perform one or more operations related to any one of the foregoing clauses.

Clause 34. A system comprising: a microphone array and a computing device comprising at least one processor and a memory storing instructions.

Clause 35. The system of clause 34, the microphone array configured to capture an audio stream associated with an audio capture area via one or more beamforming lobes.

Clause 35. The system of any of the clauses 33-34, the instructions operable, when executed by the at least one processor, to cause the computing device to: generate a first audio feature set for the audio stream.

Clause 36. The system of any of the clauses 33-35, wherein a contextual audio classification of the one or more contextual audio classifications predicts a class of audio for the audio stream.

Clause 37. The system of any of the clauses 33-36, the instructions operable, when executed by the at least one processor, to cause the computing device to: generate a context-specific mixed audio stream for the audio stream based at least in part on the one or more contextual audio classifications.

Clause 38. The system of any of the clauses 33-37, the instructions operable, when executed by the at least one processor, to cause the computing device to: generate a second audio feature set for the context-specific mixed audio stream.

Clause 39. The system of any of the clauses 33-38, the instructions operable, when executed by the at least one processor, to cause the computing device to: input the second audio feature set to a second neural network model configured to generate an audio isolation mask associated with the context-specific mixed audio stream.

Clause 40. The system of any of the clauses 33-39, the instructions operable, when executed by the at least one processor, to cause the computing device to: generate isolated audio for the context-specific mixed audio stream based at least in part on the audio isolation mask.

Clause 41. The system of any of the clauses 33-40, the instructions operable, when executed by the at least one processor, to cause the computing device to: generate output data for an output device based at least in part on the isolated audio.

Clause 42. A computer-implemented method comprising steps in accordance with any one of the foregoing clauses 33-41.

Clause 43. A computer program product, stored on a computer readable medium, comprising instructions that, when executed by one or more processors of the audio signal processing apparatus, cause the one or more processors to perform one or more operations related to any one of the foregoing clauses 33-41.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the at least one processor, to cause the apparatus to:
generate a first audio feature set for an audio stream captured via at least one capture device positioned within an environment defining at least one audio capture area;
input the first audio feature set to a first neural network model configured to generate one or more contextual audio classifications for the audio stream, wherein a contextual audio classification of the one or more contextual audio classifications predicts a class of audio for the audio stream;
generate a context-specific mixed audio stream for the audio stream based at least in part on the one or more contextual audio classifications;
generate a second audio feature set for the context-specific mixed audio stream;
input the second audio feature set to a second neural network model configured to generate an audio isolation mask associated with the context-specific mixed audio stream;
generate isolated audio for the context-specific mixed audio stream based at least in part on the audio isolation mask; and
generate output data for an output device based at least in part on the isolated audio.

2. The apparatus of claim 1, wherein the instructions are further operable to cause the apparatus to:
generate an audio contextualization mask associated with the audio stream based at least in part on the first audio feature set; and
generate the one or more contextual audio classifications for the audio stream based at least in part on the audio contextualization mask.

3. The apparatus of claim 1, wherein the instructions are further operable to cause the apparatus to:
generate the context-specific mixed audio stream by adapting gain associated with the audio stream based at least in part on the one or more contextual audio classifications.

4. The apparatus of claim 1, wherein the instructions are further operable to cause the apparatus to:
generate the context-specific mixed audio stream by controlling a noise adaptive threshold for an automatic microphone mixer based at least in part on the one or more contextual audio classifications.

5. The apparatus of claim 1, wherein the instructions are further operable to cause the apparatus to:
generate the context-specific mixed audio stream by controlling a gating decision for an automatic microphone mixer based at least in part on the one or more contextual audio classifications.

6. The apparatus of claim 1, wherein the instructions are further operable to cause the apparatus to:
generate the context-specific mixed audio stream by controlling a degree of panning associated with the audio stream based at least in part on the one or more contextual audio classifications.

7. The apparatus of claim 1, wherein the instructions are further operable to cause the apparatus to:
determine a probability score for the one or more contextual audio classifications; and
responsive to the probability score satisfying a defined probability threshold, adapt gain associated with the audio stream based at least in part on the one or more contextual audio classifications.

8. The apparatus of claim 1, wherein the instructions are further operable to cause the apparatus to:
generate isolated audio for the context-specific mixed audio stream based at least in part on (i) the audio isolation mask and (ii) one or more user audio isolation control parameters.

9. The apparatus of claim 1, wherein the instructions are further operable to cause the apparatus to:
input an audio signal sample associated with the context-specific mixed audio stream to a time-frequency domain transformation pipeline of a digital signal processing process for a transformation period;
input the audio signal sample to a deep neural network (DNN) processing loop comprising the second neural network model to generate the audio isolation mask; and
based on the audio isolation mask being determined prior to expiration of the transformation period, apply the audio isolation mask to a frequency domain version of the audio signal sample associated with the time-frequency domain transformation pipeline to generate the isolated audio.

10. The apparatus of claim 1, wherein the instructions are further operable to cause the apparatus to:
perform beam steering associated with the at least one capture device based at least in part on the audio isolation mask.

11. The apparatus of claim 1, wherein the instructions are further operable to cause the apparatus to:
modify a shape of a beamforming lobe associated with the at least one capture device based at least in part on the audio isolation mask.

12. The apparatus of claim 1, wherein the instructions are further operable to cause the apparatus to:
initiate selection of an audio channel associated with desirable audio based at least in part on the audio isolation mask.

13. The apparatus of claim 1, wherein the audio isolation mask comprises a denoiser mask, a speech removal mask, or a signal of interest mask.

14. The apparatus of claim 1, wherein the output data comprises mono audio, stereo audio, or three-dimensional audio.

15. The apparatus of claim 1, wherein the output data comprises (i) a sub-mix audio channel associated with spatial audio, (ii) broadcast audio, (iii) speech reinforcement audio, (iv) visual data configured to render via a display of the output device, or (v) a video stream associated with the isolated audio.

16. The apparatus of claim 1, wherein the output device is a haptic device, and wherein the output data comprises a control signal for the haptic device.

17. A computer-implemented method comprising:
generating a first audio feature set for an audio stream captured via at least one capture device positioned within an environment defining at least one audio capture area;
inputting the first audio feature set to a first neural network model configured to generate one or more contextual audio classifications for the audio stream, wherein a contextual audio classification of the one or more contextual audio classifications predicts a class of audio for the audio stream;
generating a context-specific mixed audio stream for the audio stream based at least in part on the one or more contextual audio classifications;
generating a second audio feature set for the context-specific mixed audio stream;
inputting the second audio feature set to a second neural network model configured to generate an audio isolation mask associated with the context-specific mixed audio stream;
generating isolated audio for the context-specific mixed audio stream based at least in part on the audio isolation mask; and
generating output data for an output device based at least in part on the isolated audio.

18. The computer-implemented method of claim 17, wherein generating the context-specific mixed audio stream comprises adapting gain associated with the audio stream based at least in part on the one or more contextual audio classifications.

19. The computer-implemented method of claim 17, wherein generating the context-specific mixed audio stream comprises controlling a noise adaptive threshold for an automatic microphone mixer based at least in part on the one or more contextual audio classifications.

20. A system comprising:
a microphone array configured to capture an audio stream associated with an audio capture area via one or more beamforming lobes; and
a computing device comprising at least one processor and a memory storing instructions that are operable, when executed by the at least one processor, to cause the computing device to:
generate a first audio feature set for the audio stream;
input the first audio feature set to a first neural network model configured to generate one or more contextual audio classifications for the audio stream, wherein a contextual audio classification of the one or more contextual audio classifications predicts a class of audio for the audio stream;
generate a context-specific mixed audio stream for the audio stream based at least in part on the one or more contextual audio classifications;
generate a second audio feature set for the context-specific mixed audio stream;
input the second audio feature set to a second neural network model configured to generate an audio isolation mask associated with the context-specific mixed audio stream;
generate isolated audio for the context-specific mixed audio stream based at least in part on the audio isolation mask; and
generate output data for an output device based at least in part on the isolated audio.
